(19) United States
(12) Patent Application Publication
(10) Pub. No.: US 2025/0156614 A1
(43) Pub. Date: May 15, 2025

(54) APPARATUS AND METHOD FOR AUTOMATION OF SEMICONDUCTOR SYSTEM DESIGN

(71) Applicant: ITDA Semiconductor Co., Ltd., Hwaseong-si (KR)

(72) Inventors: Hoyeon JEON, Seongnam-si (KR); Ahchan KIM, Hwaseong-si (KR); Ingyu KIM, Hwaseong-si (KR)

(21) Appl. No.: 18/939,653

(22) Filed: Nov. 7, 2024

(30) Foreign Application Priority Data
Nov. 9, 2023 (KR) 10-2023-0154133
Jul. 4, 2024 (KR) 10-2024-0088477

(51) Int. Cl. G06F 30/31; G06F 115/08

(52) U.S. Cl. CPC G06F 30/31; G06F 2115/08

(57) ABSTRACT

Disclosed are a semiconductor system design automation apparatus and a semiconductor system design automation method for automating semiconductor system design based on no-code or low-code according to a simple selection and arrangement operation for a semiconductor component input by a user. The semiconductor system design automation apparatus includes a semiconductor component storage unit in which component information on various semiconductor components utilizable in semiconductor system design is stored, a semiconductor design operation input unit configured to receive a selection and arrangement operation of a user for at least one semiconductor component, and a semiconductor system automatic design unit configured to automate a design of a semiconductor system including the at least one semiconductor component according to the selection and arrangement operation of the user.

### CROSS-REFERENCE TO RELATED APPLICATION

This application claims the benefit of and priority to Korean Patent Applications No. 10-2023-0154133, filed on Nov. 9, 2023, and No. 10-2024-0088477, filed on Jul. 4, 2024, which are incorporated by reference herein in its entirety.

### TECHNICAL FIELD

The present disclosure relates to a technology for automating a design of a semiconductor system such as a system-on-chip (SoC), and more specifically, to an apparatus and method for automation of semiconductor system design which can automate a design of a semiconductor system based on no-code or low-code according to a simple selection and arrangement operation for semiconductor components input by a user.

### RELATED ART

A system-on-chip (SoC) refers to a technology for integrating various function blocks such as a central processing unit (CPU), a memory, an interface, a digital signal processing circuit, and an analog signal processing circuit into a single semiconductor integrated circuit to implement a computer system or other electronic systems, or an integrated circuit (IC) integrated according to the technology. The SoC is developing into a more complex system that includes various function blocks such as a processor, multimedia, graphics, interface, and security.

Power and clock design are important for a system-on-chip. A power and clock design process of a system-on-chip can include a power/clock diagram drawing stage, a Verilog coding and scripting stage, a first documentation stage, a unified power format/standard design constraint (UPF/SDC) file generation stage, an implementation layout design stage, a second documentation stage, a design-for-testability (DFT) controller insertion stage, a hardware system analysis stage, and a software optimization stage.

The power/clock diagram drawing stage is a stage in which a power and clock structure is visually represented and drawn as a block diagram to represent a power domain and a clock tree. In the power/clock diagram drawing stage, clock elements and their link relationships are simply represented as a diagram. The Verilog coding and scripting stage is a stage in which a register transfer level (RTL) design of hardware is performed by writing Verilog code and scripts used to define and implement functions of an SoC. That is, a developer manually generates register transfer level (RTL) code on the basis of power/clock diagram drawing results.

The first documentation stage is a stage for documentation of a design intent and structure at the beginning of a project, in which various types of documents such as various requirements specifications, architecture design, and power/clock diagrams required for stakeholders such as a verification team and a software development team are created.

The UPF/SDC file generation stage is a stage in which unified power format (UPF) and standard design constraint (SDC) files are generated to control power management and timing constraints, and inputs required for hardware synthesis are generated.

The implementation layout design stage is a stage in which an actual SoC chip layout is designed and deployed at a gate level. The second documentation stage is a stage in which various documents are updated and supplemented by reflecting changes in design and implementation in the documents. The DFT controller insertion stage is a stage in which a DFT controller and a logic circuit for testing and debugging are designed and integrated into an SoC. The hardware system analysis stage is a stage in which the operation of hardware is verified and analyzed through simulation and verification to confirm the accuracy and efficiency of the design, and the software optimization stage is a stage in which software performance is optimized by profiling and optimizing software code running on the SoC.

In stages of such an SoC design process, each of the various stakeholders independently performs the work of the stage related thereto, and information required at each stage may be different. In other words, information required for the first half of the work may be different from information required for the second half of the work. For this reason, the initial design work results of workers in the first half of a project may have problems discovered through simulation and verification in the second half of the work, and the first half of the work may have to be repeated to solve such problems. In addition, if the requirements or design goals change during the project, the initial design work may have to be repeated. While a plurality of stages is being repeated, a plurality of stakeholders needs to reflect changes in other stages and repeat similar work, which causes SoC design to take a lot of time and manpower.

### SUMMARY

The present disclosure is to solve the above problems and provides a semiconductor system design automation apparatus and a semiconductor system design automation method for automating semiconductor system design based on no-code or low-code according to a simple selection and arrangement operation for semiconductor components input by a user.

In addition, the present disclosure provides a semiconductor system design automation apparatus and a semiconductor system design automation method for automatically deriving register transfer level (RTL) code related to individual clock elements constituting a clock management unit in consideration of configuration required for an SoC clock design process.

In addition, the present disclosure provides a semiconductor system design automation apparatus and a semiconductor system design automation method for designing hardware code related to connections between internal function modules of individual clock elements constituting a clock management unit and the clock elements based on no-code.

In addition, the present disclosure provides a semiconductor system design automation apparatus and a semiconductor system design automation method using no-code for automatically deriving register transfer level (RTL) code related to programmable sequences constituting a power management unit in consideration of configuration required for an SoC power design process.

An apparatus for automation of semiconductor system design according to an embodiment of the present disclosure includes a semiconductor component storage unit in which component information on various semiconductor components utilizable in semiconductor system design is stored, a semiconductor design operation input unit configured to receive a selection and arrangement operation of a user for at least one semiconductor component, and a semiconductor system automatic design unit configured to automate a design of a semiconductor system including the at least one semiconductor component according to the selection and arrangement operation of the user.

The semiconductor design operation input unit may include a graphical user interface configured to perform a selection and arrangement operation on the semiconductor component according to a drag-and-drop operation of the user for the semiconductor component.

The semiconductor components may include at least one of one or more clock components constituting a clock management unit design of a semiconductor system, one or more power components constituting a power management unit design of a semiconductor system, and one or more semiconductor circuit components constituting a semiconductor circuit design of a semiconductor system.

The semiconductor design operation input unit may provide a graphical user interface for inputting, by drawing, a clock diagram representing a clock management unit, a power diagram representing a power management unit, and an IP diagram representing a connection relationship between a semiconductor circuit block and the clock management unit and the power management unit to a computing device.

The semiconductor system automatic design unit may include at least one of a clock management unit automatic design unit configured to automate a design of the clock management unit, a power management unit automatic design unit configured to automate a design of the power management unit, and a semiconductor circuit automatic design unit configured to automate a design of the semiconductor circuit.

The semiconductor system automatic design unit may define at least some of the component information on the basis of drawing information of the clock diagram, the power diagram, and the IP diagram drawn through the graphical user interface.

The semiconductor system automatic design unit may include an instance processor configured to design an instance related to the semiconductor component on the basis of a field value of a register defining a function of an individual component, and a hardware code processor configured to generate an element based on a plurality of instances and generate hardware code related to the design of the element.

The hardware code processor may generate a register module related to the element and generate the hardware code by combining the element and the register module.

The apparatus for automation of semiconductor system design according to an embodiment of the present disclosure may further include a hardware code logic storage configured to store hardware code logic for generating a designed instance as hardware code.

The instance processor may design a new instance by setting a field value of a register defining a function of the new instance on the basis of component information of a preceding instance generated prior to the new instance and component information of the new instance. The hardware code processor may generate a register module related to an element including the preceding instance and the new instance on the basis of the field value of the register of the designed new instance and the hardware code logic, and generate the hardware code by combining the element and the register module.

The hardware code generated by the hardware code processor may include hardware code for a function module enabled on the basis of a setting value of a register field of the new instance, information on an enabled function module of the new instance, and the hardware code logic, hardware code of the register module for operating the enabled function module, and hardware code of a port and hardware code of a connection for connecting the register module and the enabled function module.

The semiconductor system automatic design unit may automatically generate the hardware code by the hardware code processor according to the selection and arrangement operation of the user for the semiconductor components to automate a design of the semiconductor system based on no-code.

The semiconductor component storage unit may include a component storage in which component information for defining a register address and a field value of the instance is stored.

The component information may include an address range allocated to an individual component, an alignment size of an individual component, a base register offset size of an individual component, and configuration field information of an individual component.

The configuration field information of an individual component may include a field name, a bit position, a bit size, access permission, and an initial value.

The apparatus for automation of semiconductor system design may further include a code logic storage in which software code logic for generating code based on an instruction instance is stored.

The semiconductor component storage unit may include a component storage in which the component information and instruction component information are stored.

The semiconductor system automatic design unit may generate one or more instances constituting a programmable sequencer on the basis of the component information, generate a first instruction instance on the basis of the instruction component information, determine a target instance related to the first instruction instance among the one or more instances and sets a value, and generate code including an instruction, a register address, and data on the basis of the first instruction instance, the target instance, and the value.

The instruction component information may include at least one of a write component for writing a specific value to a specific register field, a readwait component for waiting for a specific value to be input to a specific register field, a wait component for waiting for a predetermined period of time, an if component for branching depending on a condition, a goto component for moving to a specific position, and a call component for moving to a specific position but being able to return.

The component information may include at least one of an attribute of the semiconductor component, a control signal related to the semiconductor component, a clock frequency setting, a power state setting, a power control sequence, and a voltage setting of the semiconductor component.

A method of automating semiconductor system design according to an embodiment of the present disclosure includes receiving, by a semiconductor design operation input unit, a selection and arrangement operation of a user for at least one semiconductor component among various semiconductor components utilizable in semiconductor system design, and automating, by a semiconductor system automatic design unit, a design of a semiconductor system including the at least one semiconductor component on the basis of the selection and arrangement operation of the user.

The receiving may include performing, by a graphical user interface unit, a selection and arrangement operation on the semiconductor component according to a drag-and-drop operation of the user for the semiconductor component.

The automating of the design of a semiconductor system may include designing an instance related to the semiconductor component on the basis of a field value of a register defining a function of an individual component, generating an element based on a plurality of instances, and generating hardware code related to the design of the element.

The generating of the hardware code may include generating a register module related to the element and generating the hardware code by combining the element and the register module.

The designing of an instance may include designing a new instance by setting a field value of a register defining a function of the new instance on the basis of component information of a preceding instance generated prior to the new instance and component information of the new instance.

The generating of the hardware code may include generating a register module related to an element including the preceding instance and the new instance on the basis of a field value of a register of the designed new instance and hardware code logic, and generating the hardware code by combining the element and the register module.

The automating of the design of a semiconductor system may include generating one or more instances constituting a programmable sequencer on the basis of component information stored in a component storage of a semiconductor component storage unit, generating a first instruction instance on the basis of instruction component information stored in the component storage, determining a target instance related to the first instruction instance among the one or more instances and setting a value, and generating code including an instruction, a register address, and data on the basis of the first instruction instance, the target instance, and the value.

The receiving may include providing a graphical user interface for inputting, by drawing, a clock diagram representing a clock management unit, a power diagram representing a power management unit, and an IP diagram representing a connection relationship between a semiconductor circuit block and the clock management unit and the power management unit to a computing device.

The automating of the design of a semiconductor system may include defining component information regarding the semiconductor component on the basis of drawing information of the clock diagram, the power diagram, and the IP diagram drawn through the graphical user interface.

The automating of the design of a semiconductor system may include automatically generating hardware code related to the semiconductor system according to a selection and arrangement operations of the user for the semiconductor components to automate the design of the semiconductor system based on no-code.

According to an embodiment of the present disclosure, a computer-readable non-transitory recording medium on which a computer program for executing the method of automating semiconductor system design is recorded is provided.

According to an embodiment of the present disclosure, when designing a semiconductor system such as a system-on-chip, semiconductor system design can be automated on the basis of no-code or low-code according to a simple selection and arrangement operation for semiconductor components input by a user.

In various embodiments of the present disclosure, even if a worker does not have coding knowledge or clock process knowledge, individual elements can be automatically designed such that configuration required throughout the entire process of semiconductor system design are considered, and a global optimization design of individual elements can be easily implemented.

In various embodiments of the present disclosure, hardware code (register transfer level (RTL) code) related to an individual element can be automatically derived, and hardware code related to connections between individual element internal function modules and individual elements can be designed based on no-code, and thus the efficiency of design work can be effectively improved.

In various embodiments of the present disclosure, the efficiency of design work can be effectively improved by automatically deriving a clock management unit or semiconductor circuit design and individual element internal function modules.

In various embodiments of the present disclosure, a programmable sequencer constituting a power management unit or the like can be designed based on no-code, and hardware code related to the programmable sequencer, i.e., register transfer level (RTL) code, can be automatically derived to effectively improve the efficiency of design work.

In various embodiments of the present disclosure, even if a worker does not have coding knowledge or clock process knowledge, the programmable sequencer can be designed by considering configuration required throughout the semiconductor system power design process, and thus global optimization can be easily achieved.

The effects of the present disclosure are not limited to the effects mentioned above, and other effects not mentioned can be clearly understood by a person having ordinary knowledge in the technical field to which the present disclosure belongs (referred to as “those skilled in the art”) from the description of the claims.

### BRIEF DESCRIPTION OF THE DRAWINGS

Embodiments of the present disclosure will be described with reference to the accompanying drawings, wherein like reference numerals represent like elements, but are not limited thereto.

FIG. 1A is a configuration diagram of a semiconductor system design automation apparatus according to an embodiment of the present disclosure.

FIG. 1B is a flowchart of a semiconductor system design automation method according to an embodiment of the present disclosure.

FIG. 1C is a block diagram illustrating a system-on-chip (SoC) designed according to an embodiment of the present disclosure.

FIG. 2 is a detailed block diagram of a clock management unit included in the SoC of FIG. 1C.

FIG. 3 is a configuration diagram of a system for no-code designing a clock element according to the present disclosure.

FIG. 4 is a diagram showing an example of a display screen of a clock element no-code design system according to the present disclosure.

FIG. 5 shows an example of address ranges of registers allocated to clock components.

FIG. 6 shows an example of a register address allocation state for three clock divider instances.

FIG. 7 is an operation flowchart showing a clock element no-code design method according to the present disclosure.

FIG. 8 is a configuration diagram of a no-code type clock management unit design system according to an embodiment of the present disclosure.

FIG. 9 is a block diagram showing internal function modules of a clock multiplexer component according to the present disclosure.

FIG. 10 is a block diagram showing internal function modules of a clock divider component according to the present disclosure.

FIG. 11 is a block diagram showing internal function modules of a clock gate component according to the present disclosure.

FIG. 12 is an operation flowchart showing a no-code type clock management unit design method according to the present disclosure.

FIG. 13 is a configuration diagram of a system-on-chip (SoC) to be designed in the present disclosure.

FIG. 14 is a configuration diagram of a domain power manager of FIG. 13.

FIG. 15 illustrates a power state transition diagram of a power domain of the present disclosure.

FIG. 16 is a diagram illustrating an example of a power up sequence and a power-down sequence performed in the domain power manager of the present disclosure.

FIG. 17 is a diagram showing a no-code type programmable sequencer design system according to the present disclosure.

FIG. 18 is a diagram showing an example of a display screen of the no-code type programmable sequencer design system according to the present disclosure.

FIG. 19 illustrates a diagram of a power manager displayed in a design window.

FIG. 20 illustrates a diagram of a root power manager displayed in a design window.

FIG. 21 illustrates a diagram of a domain power manager displayed in a design window.

FIG. 22 illustrates an execution process diagram of a programmable sequencer displayed in a design window.

FIG. 23 illustrates a target power instance setting screen of an arbitrary instruction instance.

FIG. 24 is an operation flowchart showing a no-code type programmable sequencer design method according to the present disclosure.

FIG. 25 illustrates an exemplary computing device for performing the above-described method and/or embodiments.

### DETAILED DESCRIPTION OF EMBODIMENTS

Hereinafter, specific details for implementing the present disclosure will be described in detail with reference to the attached drawings. However, in the following description, a detailed description of known functions and configurations incorporated herein will be omitted when it may obscure the subject matter of the present disclosure. The same reference numbers will be used in the drawings to refer to the same or like parts. In the description of embodiments below, redundant descriptions of identical or corresponding components may be omitted. However, even if the description of a component is omitted, it is not intended that such a component is not included in any embodiment.

The advantages and features of the embodiments disclosed in this specification, and methods for achieving the same will become clear with reference to the embodiments described below together with the attached drawings. However, the present disclosure is not limited to the embodiments disclosed below, but may be implemented in various different forms, and the embodiments are only provided to fully inform a person skilled in the art related to the present disclosure of the scope of the present disclosure.

The terms used in this specification will be briefly described, and the disclosed embodiments will be specifically described. The terms used in this specification are selected from the most widely used general terms in consideration of the functions in the present disclosure, but they may vary depending on the intention of engineers in the relevant field, precedents, or the emergence of new technologies, and in certain cases, there are terms arbitrarily selected by the applicant, and in this case, the meanings thereof will be described in detail in description of the relevant disclosure. Therefore, the terms used in this specification should be defined based on the meaning of the terms and the overall content of the present disclosure, not simply the names of the terms.

In this specification, singular expressions include plural expressions unless the context clearly specifies that they are singular. In addition, plural expressions include singular expressions unless the context clearly specifies that they are plural. When a part of the entire specification includes a certain component, this does not mean that other components are excluded, but that other components may be included, unless otherwise specifically stated.

In the present disclosure, the terms “comprise,” “comprising,” and the like may indicate the presence of features, steps, operations, elements, and/or components, and such terms do not exclude the addition of one or more other functions, steps, operations, elements, components, and/or combinations thereof.

In the present disclosure, when a specific component is referred to as being “coupled”, “combined”, “connected”, “associated”, or “reacted” with any other component, the specific component may be directly coupled, combined, connected, and/or associated or reacted with the other component, but is not limited thereto. For example, one or more intermediate components may exist between the specific component and the other component. In addition, “and/or” in the present disclosure may include each of one or more listed items or a combination of at least a part of one or more items.

In the present disclosure, the terms “first”, “second”, and the like are used to distinguish a specific component from other components, and the components described above are not limited by these terms. For example, a “first” component may be used to refer to an element having the same or similar form as a “second” component.

A semiconductor system design automation apparatus according to an embodiment of the present disclosure may include a semiconductor component storage unit that stores component information regarding various semiconductor components that can be utilized in semiconductor system design, a semiconductor design operation input unit that receives a selection and arrangement operation from a user with respect to at least one semiconductor component, and a semiconductor system automatic design unit that automates a design of a semiconductor system including at least one semiconductor component according to the selection and arrangement operation of the user.

In various embodiments of the present disclosure, “components” or “semiconductor components” may be tools that can be utilized in semiconductor system design. Examples of components include clock tools (clock components) that can be utilized in clock management unit design, power management tools (power components) that can be utilized in power management unit design, and logic element tools (logic element components) that can be utilized in semiconductor logic circuit design.

“Clock components” may be clock tools that can be utilized in clock management unit design. Clock components may include a PLL controller component, a clock divider component, a clock multiplexer component, a clock gate component, etc. In embodiments of the present disclosure, clock components may be displayed as icons in a clock component window. Component information on each clock component may include address ranges allocated to each icon and clock component, alignment sizes of individual clock components, a base register offset size for each clock component, an extended register offset size for each clock component, configuration field information (field name, bit position, bit size, access permission, initial value, etc.) for each clock component, and the like.

“Power components” may be tools that can be utilized in programmable sequencer design. Examples of power components that can be utilized in domain power manager design include a reset component, an isolation component, a switch control component, a retention component, an automatic power manager component, a reference clock gating component, a memory component, a handshake component, a clock link component, a P-channel handshake component, a user-defined output component, a user-defined input component, etc.

Examples of power components that can be utilized in root power manager design include an information register creation component, a timeout register creation component, an upper information transfer register creation component, an internal register storage component, an internal register control interrupt creation component, an external input control interrupt creation component, a timer creation component, a domain power manager connection component, etc.

In various embodiments of the present disclosure, an “instance” may be a semiconductor component added to a design window by user operation. That is, an instance may be a component included in a semiconductor system design. Examples of instances include a clock instance, a power instance, a semiconductor logic circuit instance, etc.

A “clock instance” may be a clock component added to a design window by user operation. That is, the clock instance may be a clock component included in a clock manager design. When the user performs a drag & drop operation on an arbitrary clock component icon on a clock component window to move the clock component icon to a design window area using a graphical user interface, a clock instance related to the clock component can be created.

When the clock instance is created, a base register and, optionally, an extended register of the clock instance can be automatically created. Field values constituting the base register and the optionally created extended register may be preset or may be changed by user input. The clock management unit may include a plurality of clock instances for each type of clock component.

A clock instance generated on the basis of a PLL controller component is referred to as a PLL controller instance, a clock instance generated on the basis of a clock divider component is referred to as a clock divider instance, a clock instance generated on the basis of a clock multiplexer component is referred to as a clock multiplexer instance, and a clock instance generated on the basis of a clock gate component is referred to as a clock gate instance.

Each clock instance may include at least one basic function module and optionally at least one enabled extended function module. When a clock instance is created, base register field values may be automatically assigned, and if the clock instance includes an extended register, extended register field values may be automatically assigned. Some register field values may be changed according to user input. In addition, hardware code may be generated on the basis of set base register field values and extended register field values of the clock instance.

A “power instance” may be a power component added to a design window by user operation. In other words, the power instance may be a power component included in a programmable sequencer design. When the user drags and drops an arbitrary power component icon on a power component window to a design window area, a power instance related to the power component can be created.

When the power instance is created, a register related to the power instance can be automatically created. Field values constituting registers created for each power instance may be preset or may be changed by user input. A programmable sequencer may include a plurality of power instances for each type of power component.

A power instance generated on the basis of a reset component is referred to as a reset instance, a power instance generated on the basis of an isolation component is referred to as an isolation instance, a power instance generated on the basis of a switch control component is referred to as a switch control instance, and a power instance generated on the basis of a retention component is referred to as a retention instance. In addition, an individual power instance may be generated on the basis of each power component. When a power instance is generated, register field values allocated to the power instance may be automatically assigned. Additionally, hardware code may be generated on the basis of the register field values of the power instance.

In various embodiments of the present disclosure, an “element” is a hardware-coded module based on a designed clock instance, which can configure an individual management unit for semiconductor system design. Examples of elements include a clock element, a power element, and a semiconductor circuit element.

A clock element is a hardware-coded module based on a designed clock instance, which can configure a clock management unit. A power element is a hardware-coded module based on a designed power instance, which can configure a programmable sequencer.

In summary, a “component” is a material for designing an individual management unit for semiconductor system design, an “instance” is a node included in an individual management unit design, and an “element” is a module that is implemented as hardware code based on a designed instance and can operate in an individual management unit (clock management unit, power management unit, semiconductor circuit management unit, etc.).

For example, a clock component is a material for designing a clock management unit, a clock instance is a node included in a clock management unit design, and a clock element is a module that is implemented as hardware code based on a designed clock instance and can operate in a clock management unit.

In another example, the power component is a material for designing a programmable sequencer, the power instance is a node included in a design of each programmable sequencer, and the power element may be a module that is implemented as hardware code based on a designed power instance and can operate in a programmable sequencer.

In various embodiments of the present disclosure, instruction components may be tools that can be utilized in designing the operation of a power element constituting a programmable sequencer. Instruction components may include a write component for writing a specific value to a specific register field, a readwait component for waiting for a specific value to be input to a specific register field, a wait component for waiting for a certain period of time, an if component for branching according to a condition, a goto component for moving to a specific position, a call component for moving to a specific position but being able to return, a label component, a start component, and an end component.

An instruction instance may be an instruction component added to a design window by user operation. A power instance and a value may be set to an instruction instance. An instruction may be determined according to an instruction instance, a register field address may be determined according to a power instance, and data may be determined according to a value. The binary code of the instruction, register address, and data determined in this manner may be stored in a memory.

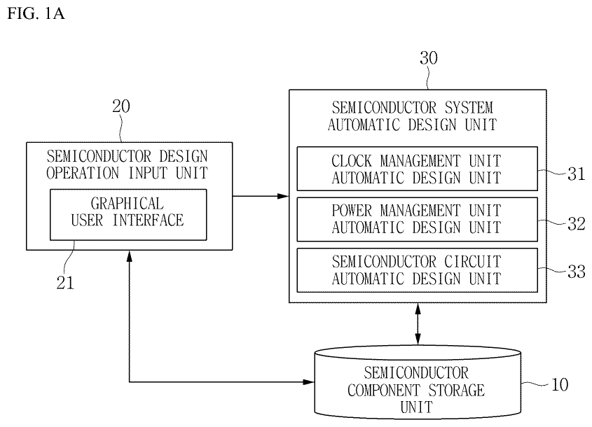

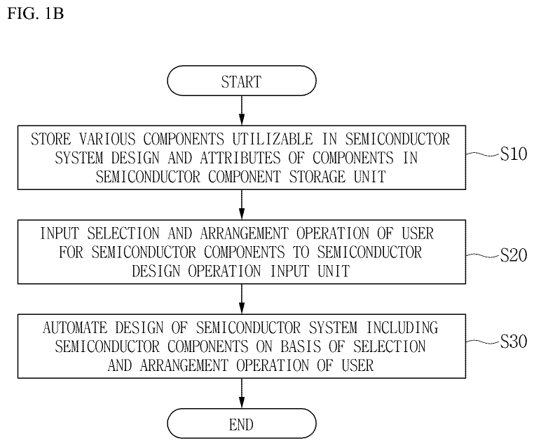

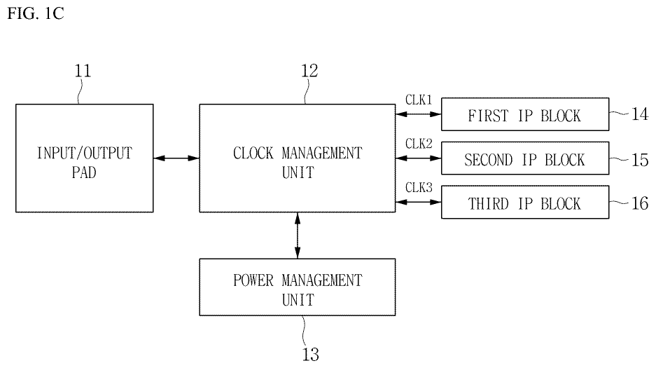

FIG. 1A is a configuration diagram of a semiconductor system design automation apparatus according to an embodiment of the present disclosure. FIG. 1B is a flowchart of a semiconductor system design automation method according to an embodiment of the present disclosure. Referring to FIG. 1A and FIG. 1B, the semiconductor system design automation apparatus according to an embodiment of the present disclosure may include a semiconductor component storage unit 10, a semiconductor design operation input unit 20, and a semiconductor system automatic design unit 30.

The semiconductor component storage unit 10 may store component information on various semiconductor components that can be used in semiconductor system design (S10). The components may include one or more clock components that constitute a clock management unit design of a semiconductor system, one or more power components that constitute a power management unit design of the semiconductor system, and/or one or more logic element components that constitute a logic circuit design of the semiconductor system.

The component information may include icons of the semiconductor components, properties of the semiconductor components, control signals related to the semiconductor components, a clock frequency setting, a power state setting, power control sequences, and a voltage setting of the semiconductor components. The properties of the semiconductor components may include, for example, information on a hardware design state. Hardware design properties of the semiconductor components and control signal information used to control the semiconductor components are parts that do not change after the design of the semiconductor component is completed.

The component information may include not only static hardware properties that do not change after the design of the semiconductor component but also component configuration information, which is a set of states in which the semiconductor components are configured. Depending on a value of the component configuration information set for each semiconductor component, the relevant semiconductor component can have a different state.

Such component configuration information includes clock frequency configuration information indicating the frequency of a clock signal input to a semiconductor component, power state configuration information indicating information on the state of power applied to the semiconductor component, power control sequence information indicating information regarding a control sequence of power applied to the semiconductor component, and voltage configuration information indicating a voltage setting applied to the semiconductor component. For example, in clock management unit design, a clock component may have different states depending on how the clock component is configured. That is, even if clock components are identical, multiple clock frequency configurations that can be applied to the operations of the clock components may be present, and clock frequency configuration information may indicate a configuration state from among various configuration states that a clock component can have.

As another example, in the case of a power component, the power component can have different states depending on values set thereto. For example, a reset signal input for a reset operation of the power component is set to have a value of “1” in a power-up state and to have a value of “0” in a power-down state. Accordingly, multiple power state configurations for the operation of the power component can be present, which also applies to power control sequence information or voltage configuration information.

Accordingly, when a database (DB) is constructed in the semiconductor component storage unit, the database may be divided into a design DB and a configuration DB to store component information of semiconductor components. Accordingly, hardware design information of semiconductor components indicating a state of static hardware may be stored in the design DB, and configuration information indicating different states depending on configurations may be stored in the configuration DB. The design DB and the configuration DB may be constructed such that they form a pair for each semiconductor component.

The semiconductor component storage unit 10 may store not only component information of the semiconductor components but also attribute information of a clock management unit and a power management unit, clock frequency configuration information, control signal information, a clock diagram (a diagram showing a state in which clock components are connected), a power diagram (a diagram showing a state in which power components are connected), an IP diagram (a diagram reflecting a connection design between clock nodes and IP blocks such as logic circuits and semiconductor circuits), and the like.

The attribute information of the clock management unit may include a clock management unit module name, reference clock information (clock for the operation of the clock management unit itself, such as a clock component controller and a clock component interface), control signal interface clock information (frequency clock the same as a clock at which a master interface of a bus connected to the clock management unit operates), external control signal interface type (TX indicating transmission or RX indicating reception), and the like.

The reference clock information and the control signal interface clock information may be specified by selecting one of the labels in the clock diagram. The user may change, delete, or add semiconductor components in the clock diagram and/or the IP diagram by dragging & dropping the semiconductor components through a GUI, and may select (click) each semiconductor component to input, modify, or delete attribute information regarding the semiconductor component. The component information of the clock component may include common attributes such as the clock component name, and external clock path/custom clock control (information for a controller of the clock component to receive control signals and custom control signals and transmit the same to the clock component).

The power component may include a domain power manager (PMD) component that configures a domain power manager (Power Management for Domain) for controlling a power domain, a root power manager (PMR) component that configures a root power manager for managing the domain power manager, and a power manager (PMC) component that configures and combines modules referenced by the PMR manager and the PMD manager.

Component information on the PMD component and the PMR component may include PMD/PMR component names, power state configuration information, control signal information, and the like. Component information on the PMC component may include a PMC component name, module reference information (configuration information indicating modules referenced by the PMR manager and the PMD manager of the PMC diagram), and the like.

The semiconductor design operation input unit 20 may receive a selection and arrangement operation of a user with respect to at least one semiconductor component among components (S20). The semiconductor design operation input unit 20 may include a graphical user interface 21 for performing a selection and arrangement operation on semiconductor components according to a drag & drop operation of the user for the semiconductor components. The graphical user interface 21 may receive a selection and arrangement operation of the user with respect to the semiconductor components on the basis of a graphical user interface (GUI), that is, a visual interface that allows a user to interact with a computer system.

The GUI provides an intuitive and easy-to-use environment to the user by using graphical elements such as icons, buttons, menus, windows, and dialog boxes. The user may select and arrange semiconductor components by the GUI using a user input device such as a keyboard, a mouse, or a touchpad, and may connect the semiconductor components using the GUI.

The semiconductor system automatic design unit 30 may automate a design of a semiconductor system including semiconductor components on the basis of a selection and arrangement operation of the user (S30). The semiconductor system automatic design unit 30 may include a clock management unit automatic design unit 31, a power management unit automatic design unit 32, and a semiconductor circuit automatic design unit 33.

The clock management unit automatic design unit 31 may automate a design of a clock management unit of the semiconductor system. The power management unit automatic design unit 32 may automate a design of a power management unit of the semiconductor system. The semiconductor circuit automatic design unit 33 may automate a design of a logic circuit (semiconductor circuit) of the semiconductor system.

The semiconductor system automatic design unit 30 may include an instance processor that designs an instance related to a semiconductor component on the basis of a field value of a register that defines the function of an individual component, and a hardware code processor that generates an element on the basis of a plurality of instances and generates a hardware code related to the design of the element. The hardware code processor may generate a register module related to the element and generate the hardware code by combining the element and the register module.

The semiconductor system design automation apparatus according to an embodiment of the present disclosure may further include a hardware code logic storage unit (not shown) that stores hardware code logic for generating a designed instance as a hardware code. The instance processor may design a new instance by setting a field value of a register that defines a function of the new instance on the basis of component information of a preceding instance generated prior to the new instance and component information of the new instance.

The hardware code processor may generate a register module related to an element including the preceding instance and the new instance on the basis of the field value of the register of the designed new instance and hardware code logic, and generate a hardware code by combining the element and the register module.

The hardware code generated by the hardware code processor may include hardware code for a function module enabled on the basis of the setting value of the register field of the new instance, an enabled function module information of the new instance, and the hardware code logic, hardware code of a register module for operating an enabled function module, and hardware code of a port for connecting the register module and the enabled function module, and hardware code of connection.

The semiconductor system automatic design unit 30 may automatically generate hardware code by the hardware code processor according to a selection and arrangement operation of the user with respect to semiconductor components, thereby automating semiconductor system design based on no-code. Alternatively, the semiconductor system automatic design unit 30 may automatically generate hardware code related to element design including semiconductor components by the hardware code processor according to a selection and arrangement operation of the user with respect to the semiconductor components and additional hardware code input of the user, thereby automating semiconductor system design based on low-code.

The semiconductor component storage unit 10 may include a component storage in which component information for defining register addresses and field values of instances is stored. The component information may include an address range allocated to an individual component, an alignment size of an individual component, a base register offset size for an individual component, and configuration field information of an individual component. The configuration field information of an individual component may include a field name, a bit position, a bit size, access permission, and an initial value.

The semiconductor system design automation apparatus according to the embodiment of the present disclosure may further include a code logic storage (not shown) in which software code logic for generating code on the basis of an instruction instance is stored. The semiconductor component storage unit may include a component storage in which component information and instruction component information are stored.

In the embodiment of the present disclosure, the semiconductor system automatic design unit 30 may generate one or more instances constituting a programmable sequencer on the basis of components, generate a first instruction instance on the basis of instruction component information, determine a target instance related to the first instruction instance among the one or more instances and set a value, and generate code including an instruction, a register address, and data on the basis of the first instruction instance, the target instance, and the value.

Instruction components may include at least one of a write component for writing a specific value to a specific register field, a readwait component for waiting for a specific value to be input to a specific register field, a wait component for waiting for a predetermined period of time, an if component for branching depending on a condition, a goto component for moving to a specific position, and a call component for moving to a specific position but being able to return.

In one embodiment of the present disclosure, the semiconductor system automatic design unit 30 may automate semiconductor system design by configuring an SOC including a clock management unit and a power management unit. To this end, the semiconductor system automatic design unit 30 may define an IP block in which the clock management unit, a power manager controller of the power management unit, and a power manager interface module are instantiated, and the order in which the root power manager and the domain power manager are connected.

When the user draws a clock diagram using a GUI in order to design a clock management unit, the properties of the clock management unit may be defined on the basis of clock components drawn by dragging & dropping on the clock diagram and a connection relationship between the clock components. Connection between the clock components may be performed in a simple manner, such as connecting input/output nodes of the clock components or adjusting drop positions of the clock components by the user through the GUI. The user may also additionally input, modify, or delete the properties or component information of the clock management unit. Subsequently, the user may draw an IP diagram using the GUI to define the properties of an IP block that will receive a clock from the clock management unit and additionally input component information such as clock frequency configuration information. The connection between the IP block and the clock management unit may be easily performed by the user through the GUI.

Designing of a power management unit may include a process in which the user draws a power diagram using the GUI. Root power manager and domain power manager structures may be configured on the basis of the properties of components drawn on the power diagram. The properties of the power management unit may be defined on the basis of power components drawn by dragging & dropping and a connection relationship between the power components.

Connection between power components may be performed in a simple manner, such as connecting input/output nodes of the power components or adjusting drop position of the power components by the user through the GUI. The user may also add, modify, or delete the properties or component information of the power management unit. The user can additionally input component information, such as power state configuration, in the power diagram using the GUI. Connection between the IP block and the power management unit may be easily performed by the user through the GUI.

FIG. 1C is a block diagram illustrating a system-on-chip (SoC) designed according to an embodiment of the present disclosure. The SoC may include an input/output pad 11, a clock management unit (CMU) 12, a power management unit (PMU) 13, and one or more intellectual property (IP) blocks 14, 15, and 16. The IP blocks may include logic circuits, semiconductor circuits, and the like.

The clock management unit 12 may generate clock signals to be provided to the first to third IP blocks 14, 15, and 16. For example, the clock management unit 12 may generate first to third clock signals CLK1, CLK2, and CLK3. The clock management unit 12 may provide the first clock signal CLK1 to the first IP block 14, provide the second clock signal CLK2 to the second IP block 15, and provide the third clock signal CLK3 to the third IP block 16.

The first to third IP blocks 14, 15, and 16 are connected to a system bus and may communicate with each other through the system bus. Each of the first to third IP blocks 14, 15, and 16 may include a processor, a graphic processor, a memory controller, an input and output interface block, and the like.

The power management unit 13 controls the power supplied to the first IP block 14 to the third IP block 16. For example, when the SoC enters a standby mode, the power management unit 13 can cut off the power provided to the first IP block 14 to the third IP block 16, thereby reducing the power consumption of the SoC.

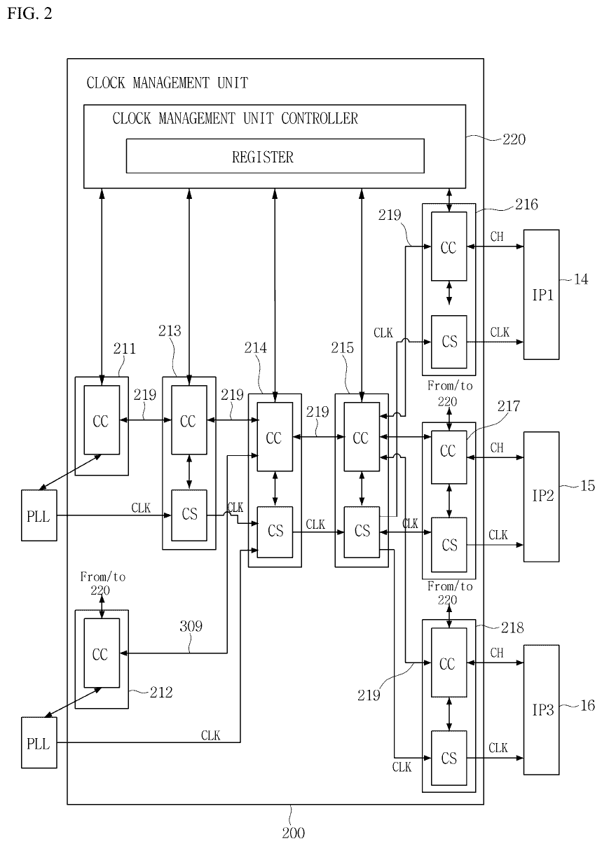

FIG. 2 is a detailed configuration block diagram of the clock management unit 12 and 200 included in the SoC of FIG. 1C. The clock management unit 200 may be the clock management unit 12 of FIG. 1C. Referring to FIG. 2, the clock management unit 200 may include a plurality of clock elements 211, 212, 213, 214, 215, 216, 217, and 218 and a clock management unit (CMU) controller 220.

The plurality of clock elements 211, 212, 213, 214, 215, 216, 217, and 218 generates clock signals CLK to be provided to the IP blocks 14, 15, and 16. The clock signals provided to the IP blocks 14, 15, and 16 may have different frequencies. The clock management unit controller 220 controls the clock elements 211, 212, 213, 214, 215, 216, 217, and 218 such that a clock signal having a frequency required by the IP blocks 14, 15, and 16 is provided.

The clock elements may include phase locked loop (PLL) controllers 211 and 212, clock dividers 213 and 215, a clock multiplexer 214, and clock gates 216, 217, and 218. Each clock element may include a clock source CS and a clock control circuit CC that controls the clock source CS. The clock source CS may include, for example, a multiplexing circuit, a divider circuit, and a gating circuit. The PLL controllers 211 and 212 do not include a clock source and may control a PLL outside the clock management unit 200.

Each of the clock dividers 213 and 215 includes a division circuit as a clock source CS, and the clock control circuit CC of each of the clock dividers 213 and 215 controls the division circuit. The division circuit divides and outputs an input clock signal, and the clock control circuit CC may control the division ratio of the division circuit.

The clock multiplexer 214 includes a multiplexing circuit as a clock source CS, and the clock control circuit CC of the clock multiplexer 214 controls the multiplexing circuit. The multiplexing circuit selectively outputs one of a plurality of input clock signals. The clock control circuit CC may control an input clock signal to be selected and output by the multiplexing circuit.

Each of the clock gates 216, 217, and 218 includes a gating circuit as a clock source CS, and the clock control circuits CC of each of the clock gates 216, 217, and 218 controls the gating circuit. The gating circuit enables a clock signal only when an operation is required, and blocks the clock signal otherwise to interrupt the operation of the circuit, thereby controlling unnecessary clock signals. The clock control circuit CC can control the gating circuit such that the gating circuit stops or enables a clock signal.

The clock element 211 is a parent of the clock element 213, and the clock element 213 is a child of the clock element 211 and a parent of the clock element 214. The clock element 214 is a child of two clock elements 212 and 213 and a parent of the clock element 215. The clock element 215 is a child of the clock element 214 and a parent of three clock elements 216, 217, and 218. Meanwhile, the clock elements 211 and 212 including a PLL controller are root clock elements, and the clock elements 216, 217 and 218) located close to the IP blocks 14, 15, and 16 and including the gating circuits are leaf clock elements.

Such a parent-child relationship may be established between clock control circuits CC and between clock sources CS according to the parent-child relationship between the clock elements 211, 212, 213, 214, 215, 216, 217, and 218. A signal line 219 is connected between the clock control circuits CC such that the two clock control circuits CC can communicate through the signal line 219. A clock signal CLK may be transferred from a parent clock source CS to a child clock source CS.

The clock management unit controller 220 includes a register, and information necessary to control and set the operation of the clock management unit 200 is recorded in the register as a register transfer level (RTL) code. In addition, the RTL code describing the operation of the clock control circuit of each clock element is written in the register of the clock management unit controller 220, and this RTL code may be implemented as actual clock management unit hardware using a hardware design tool. In the present disclosure, the RTL code and hardware code may be used interchangeably.

Therefore, in order to configure the clock management unit, RTL code for each clock element needs to be generated, and RTL code describing the operation of each clock element needs to be generated and stored in the register of the clock management unit controller. In the past, developers manually generated hardware code using Verilog code on the basis of clock diagram drawing results.

The present disclosure proposes a no-code type clock element design system and method for enabling various operation characteristics of a clock element to be set on the basis of a graphical user interface (GUI) and deriving RTL code related to the clock element in a no-code manner on the basis of the set operation characteristics.

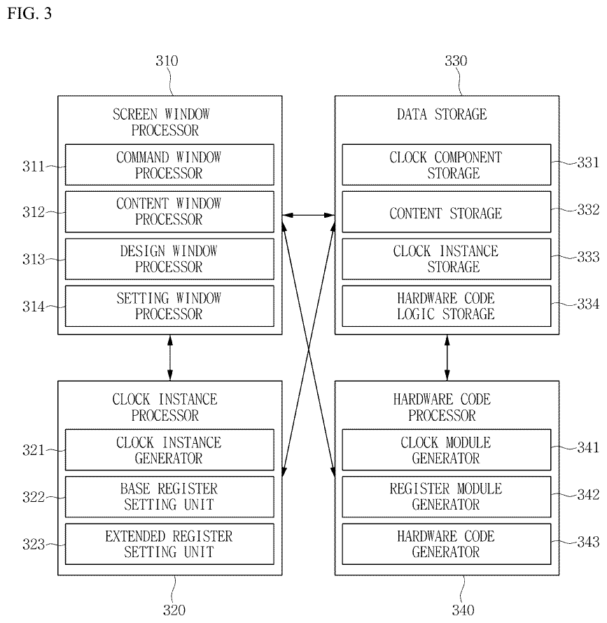

FIG. 3 is a configuration diagram of a system for designing a clock element based on no-code according to the present disclosure. The clock element no-code design system according to the present disclosure may be implemented as a computer system. The clock element no-code design system according to the present disclosure may include a screen window processor 310 that detects a user input and outputs a processing result for the user input on a display screen, a clock instance processor 320 that generates a clock instance on the basis of clock component information and designs the clock instance by setting a field value of a base register that defines a basic function of the clock instance, a data storage 330 in which hardware code logic for generating hardware code on the basis of clock component information, information on a designed clock instance, and the designed clock instance are stored, and a hardware code processor 340 that generates a clock element on the basis of information on the designed clock instance, generates a register module related to the clock element, and generates hardware code by combining the clock element and the register module. The clock instance processor 320 may design a clock instance by setting an extended register field value that defines an extended function of the clock instance.

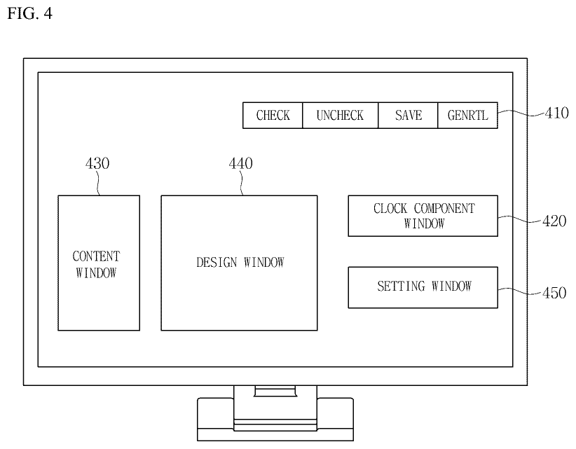

FIG. 4 is a diagram showing an example of a display screen of the clock element no-code design system according to the present disclosure. The display screen of the clock element no-code design system of the present disclosure may include a command window 410 through which a user command is input, a clock component window 420 in which clock component icons are displayed, a content window 430 in which an environment for adding, deleting, and changing a list of clock management units under design is provided and a list of clock instances constituting each clock management unit under design and base register information of each clock instance are hierarchically displayed, a design window 440 in which a clock diagram of the clock management unit under design is displayed and an environment for adding, deleting, and changing clock instances constituting the clock management unit under design is provided, and a setting window 450 in which a setting value change environment for a clock instance selected in the design window is provided. The content window 430 may further hierarchically display extended register information of each clock instance.

The command window 410 may include a CHECK button for receiving a check command for errors in a clock diagram of the clock management unit under design, setting values of clock instances constituting the clock management unit under design, and a connection between parent and child clock instances, an UNCHECK button for receiving a command for deactivating a check result, a SAVE button for receiving a save command for the clock diagram displayed in the design window 440, and a GENRTL button for receiving a hardware code generation command for the clock diagram displayed in the design window 440.

The clock component window 420 may display icons of a clock component list that can be utilized in the design of the clock management unit. Clock components include a PLL controller component, a clock divider component, a clock multiplexer component, and a clock gate component, and the clock component window 420 may further display a label component. Here, the label component is a component inserted into the input and output between any two clock components for partial design work at the time of designing a complex clock diagram, and when hardware code is generated, the label component may be ignored and the two clock components may be coded to be connected.

The content window 430 displays a list of clock management units under design and provides an environment for adding, deleting, and changing clock management units under design. In addition, the content window 430 may display a list of clock instances constituting the relevant clock management unit in the design under each clock management unit list under design, and hierarchically display base register information of each clock instance. Optionally, extended register information of the clock instance may be further displayed in the content window 430.

The clock component window 420 may display icons of a clock component list that can be utilized in designing a clock management unit. Clock components include a PLL controller component, a clock divider component, a clock multiplexer component, and a clock gate component, and the clock component window 420 may further display a label component. Here, the label component is a component that is inserted into the input and output between any two clock components for partial design work at the time of designing a complex clock diagram, and when hardware code is generated, the label component may be ignored and the two clock components may be coded to be connected.

The design window 440 displays a clock diagram of the clock management unit under design and provides an environment for adding, deleting, and changing clock instances that constitute the clock management unit under design. When the user moves any clock component in the clock component window 420 to the design window 440 by dragging and dropping the same, a clock instance may be created in the clock management unit under design, and when the clock instance is created, a new clock instance list and base register information of the new clock instance may be hierarchically added to the content window 430. Optionally, additional extended register information of the new clock instance may be added. The setting window 450 displays an environment for changing setting values for the clock instance selected in the design window 440.

The screen window processor 310 may include a command window processor 311 that displays buttons for receiving user commands on the command window 410, detects an input of each button on the command window 410, and causes an operation related to the input button to be performed, a content window processor 312 that hierarchically displays a list of clock management units under design and a list of clock instances and register information included in each clock management unit under design on the content window 430, detects a user input applied to the content window 430, and causes an operation related to the user input to be performed, a design window processor 313 that displays a clock diagram of a clock management unit under design selected by the user on the design window 440, detects a user input applied to the design window 440, and causes an operation related to the user input to be performed, and a setting window processor 314 that displays configuration information of a clock instance selected by the user on the setting window 450, detects a user input applied to the setting window 450, and causes an operation related to the user input to be performed.

When the CHECK button is selected, the command window processor 311 performs a check operation for errors in the clock diagram of the clock management unit under design, the setting values of the clock instances that constitute the clock management unit under design, and the connection between parent and child clock instances and causes a part where an error has occurred to be displayed. When the UNCHECK button is selected, the command window processor 311 restores an error part displayed in the clock diagram of the clock management unit under design to its original state and displays the same. When the SAVE button is selected, the command window processor 311 saves the details of clock work with respect to the clock management unit under design displayed in the design window 440 in the content data storage 330. When the GENRTL button is selected, the command window processor 311 generates hardware code for the clock diagram of the clock management unit under design displayed in the design window.

The content window processor 312 provides an environment for adding, deleting, and changing a list of clock management units under design and a list of clock instances included in each clock management unit under design. The content window processor 312 hierarchically displays a clock instance list, base register information of each clock instance, and optionally extended register information under each clock management unit under design. The user can add, delete, or rename a clock management unit under design on the content window, and the list of clock management units under design may be added, deleted, or renamed in the content storage 332 in response to user input. When the user changes the name of a clock management unit under design, the content window processor 312 causes not only the name of the clock management unit under design but also the names of clock instances under the clock management unit under design, and the base register names and extended register names of the clock instances to be changed at once.

The design window processor 313 displays a clock diagram of a clock management unit under design in the design window 440 and provides an environment for adding, deleting, and changing clock instances that constitute the clock management unit under design. When the user performs an operation of adding an arbitrary clock component on the clock component window 420 to the design window 440, the design window processor 313 detects this operation and causes a clock instance addition operation to be performed.

The setting window processor 314 causes configuration information of a clock instance selected by the user to be displayed in the setting window 450, detects a user input applied to the setting window 450, and causes an operation related to the user input to be performed.

The data storage 330 may include a clock component storage 331 in which clock component information is stored, a content storage 332 in which a list of clock management units under design, a list of clock instances for each clock management unit under design, and a list of registers related to the clock instances are stored, a clock instance storage 333 in which clock instance information and register information of clock instances are stored, and a hardware code logic storage 334 in which hardware code logic for generating hardware code on the basis of information on a designed clock instance and register information is stored.

The list of registers related to clock instances may include a base register list and an extended register list. The clock component information stored in the clock component storage 331 may include an address range allocated to each clock component, an alignment size of each clock component, a base register offset size for each clock component, an extended register offset size for each clock component, and configuration field information (field name, bit position, bit size, access permission, initial value, etc.) for each clock component. The clock component information defines a register address and a field value of a clock instance generated on the basis of the relevant clock component. Information on the maximum number of clock instances for each clock component may be calculated using the address range allocated to each clock component and the alignment size of each clock component. Clock components may include a PLL controller component, a clock divider component, a clock multiplexer component, and a clock gate component.

The address range allocated to each clock component, the alignment size of each clock component, the base register offset size for each clock component, the extended register offset size for each clock component, and the configuration field information for each clock component may be determined differently.

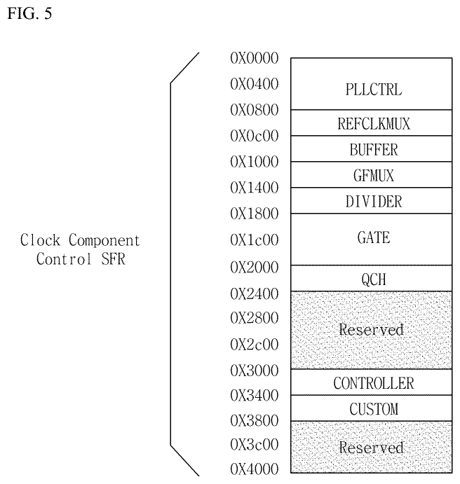

FIG. 5 shows an example of address ranges of registers allocated to clock components. For example, an address range of 0x0000 to 0x0800 may be allocated to the PLL controller component, an address range of 0x1400 to 0x1800 may be allocated to the clock divider component, an address range of 0x1000 to 0x1400 may be allocated to the clock multiplexer component, and an address range of 0x1800 to 0x2000 may be allocated to the clock gate component.

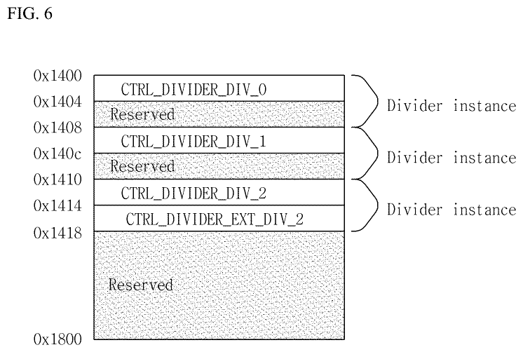

The clock management unit may include a plurality of clock instances for each type of clock component. For example, it may include three clock divider instances. FIG. 6 shows an example of a register address allocation state for three clock divider instances. The addresses of the three clock divider instances are allocated within the address range (0x1400 to 0x1800) allocated to each clock component. The register address of the first clock divider instance DIV_0 may be allocated as the start address 1×1400 of the address range allocated to the clock divider component. The register address of the second clock divider instance DIV_1 may be an address 1×1408 obtained by adding the start address of the first clock divider instance to the alignment size 0x8 thereof. The register address of the third clock divider instance may be an address 0x1414 obtained by adding the start address of the second clock divider instance to the alignment size thereof. The first and second clock divider instances only include base registers, and the third clock divider instance may include a base register and an extended register. Base register setting values of the clock divider instances are written to the clock divider instance start addresses to the base register offset sizes, and extended register setting values are written to the remainder.

The clock component storage 331 stores configuration field information (field name, bit position, bit size, access permission, initial value, etc.) for each individual clock component. This configuration field information may be different for each individual clock component type. Here, the bit position is a start address of a relevant field among the addresses allocated to an individual clock instance, the bit size is the range of the relevant field, access permission is the presence or absence of write permission (read only/read write) for the relevant field, and the initial value is an initial setting value.

The PLL controller component may include a SELECT field, a BUSY field, and a DEBUG (DBG_INFO) field as base register information and may include a power-down (DWRDOWN) field and a CUSTOM field as extended register information, and the field name, bit position, bit size, access permission, and initial value of each field may be set. Here, the SELECT field is a field for selecting a PLL type, the BUSY field is a field for monitoring whether the clock element is operating, and the DEBUG field is a field that stores debugging information.

The clock multiplexer component includes a SELECT field, a BUSY field, and a DEBUG (DBG_INFO) field as base register information and may include a THROTTLE field and a CUSTOM field as extended register information. The field name, bit position, bit size, access permission, and initial value of each field are set. Here, the SELECT field is a field for selecting the number of multiplexer inputs, the BUSY field is a field for monitoring whether the clock element is operating, and the DEBUG field is a field that stores debugging information.

The clock divider component includes a division ratio (DIVRATIO) field, a BUSY field, and a DEBUG (DBG_INFO) field as base register information and may include a power-down (DWRDOWN) field, a THROTTLE field, and a CUSTOM field as extended register information. The field name, bit position, bit size, access permission, and initial value of each field are set. The division ratio field is a field for setting a division ratio of the clock divider, the BUSY field is a field for monitoring whether the clock element is operating, and the DEBUG field is a field that stores debugging information.

The clock gate component may include an ENABLE field, a BUSY field, and a DEBUG (DBG_INFO) field as base register information and may include a SHORTSTOP field, an early wakeup (EWAKEUP) field, and a CUSTOM field as extended register information. The field name, bit position, bit size, access permission, and initial value of each field are set. The BUSY field is a field for monitoring whether the clock element is operating, and the DEBUG field is a field that stores debugging information.

The power-down (DWRDOWN) field is a field for determining whether to use a function to control the relevant clock element while a power up/down sequence of any power domain is in operation. The PLL controller instance and the clock multiplexer instance support an operation feature of forcing the output value to be overridden as 0 if the power-down field is set to a specific field value, and the clock divider instance supports an operation feature of forcing the output value to be output as a low level if the power-down field is set to a specific field value.

The THROTTLE field is a field for determining a feature of decreasing temperature by lowering the clock frequency momentarily when the temperature of the clock element increases above a certain level. The clock multiplexer instance and the clock divider instance support an operation feature of forcing the division ratio and output frequency to be changed when a throttle signal is input if the THROTTLE field is set to a specific field value.

The CUSTOM field is a field for determining the function of controlling the relevant clock element through separate custom hardware. The SHORTSTOP field supports an operation feature of stopping several cycles before and after a period in which a signal changes from 0 to 1 or 1 to 0. The SHORTSTOP field may be set in the clock gate instance. The EWAKEUP field is a field for receiving a signal from outside the clock management unit to determine whether to enable auto clock gating of the clock element.

The clock instance storage 333 stores clock instance information and register information of clock instances for each clock instance included in a clock management unit under design. The clock instance storage 333 may store the name of a clock management unit under design, the type of clock component of a clock instance, the start address of a relevant clock instance, and setting values of each register field. The setting values of each register field may be set on the basis of clock component information or may be set by reflecting user input.

The hardware code logic storage 334 stores hardware code logic for generating hardware code on the basis of information on a designed clock instance and register information.

The clock instance processor 320 may include a clock instance generator 321 that generates a new clock instance on the basis of information on a previously generated clock instance of the same clock component type and clock component information and stores the same in the clock instance storage 333, a base register setting unit 322 that sets field values of a base register that define basic functions of the new clock instance and stores the same in the clock instance storage 333, and an extended register setting unit 323 that sets field values of an extended register that define extended functions of the new clock instance and stores the same in the clock instance storage 333.

The clock instance generator 321 may be executed to generate a new clock instance when the user adds any clock component on the clock component window 420 to the design window 440. The name of the new clock instance may include the name of the clock management unit under design including the new clock instance and information on the clock component type of the new clock instance. In addition, the address of the new clock instance may be set on the basis of information on a previously generated clock instance of the same clock component type and clock component information. That is, the start address of the register of the new clock component may be determined by adding the start address of the register of the previously generated clock instance to the alignment size of the clock component information, and an initial setting value of the register field may be determined on the basis of the base register offset size, extended register offset size, and configuration field information of the clock component information.

The base register setting unit 322 may display the field name, bit position, bit size, access permission, and initial values of the configuration field included in the base register on the design window 440 or the setting window 450, and may change the same according to user input. The base register sets the essential functions of the clock source of the clock element. That is, for the PLL controller instance, a PLL type selection function, a clock element operation monitoring function, a debugging function, etc. may be set, and setting values of register fields related to the functions may be set. For the clock multiplexer instance, a multiplexer input number selection function, a clock element operation monitoring function, a debugging function, etc. may be set, and setting values of register fields related to the functions may be set. For the clock divider instance, a division ratio function, a clock element operation monitoring function, a debugging function, etc. may be set, and setting values of register fields related to the functions may be set. For the clock gate instance, an enable function, a clock element operation monitoring function, a debugging function, etc. may be set, and setting values of register fields related to the functions may be set.

The extended register setting unit 323 may display extended functions that can be set for each clock component on the screen, and when the user selects an extended function, set the field of the extended register related to the extended function. For the PLL controller instance, the power-down (DWRDOWN) function and the CUSTOM function may be selected, and setting values of an extended register field related to an extended function selected by the user may be set. For the clock multiplexer instance, the THROTTLE function and the CUSTOM function may be selected, and setting values of an extended register field related to an extended function selected by the user may be set. For the clock divider instance, the power-down (DWRDOWN) function, the THROTTLE function, and the CUSTOM function may be selected, and setting values of an extended register field related to an extended function selected by the user may be set. For the clock gate instance, the SHORTSTOP function, the early wakeup (EWAKEUP) function, and the CUSTOM function may be selected, and setting values of an extended register field related to an extended function selected by the user may be set.

The hardware code processor 340 includes a clock module generator 341 that generates a clock module on the basis of information on a designed clock instance, a register module generator 342 that generates a register module related to the clock module, and a hardware code generator 343 that generates hardware code by combining the clock module and the register module.

The hardware code processor 340 may be executed when the GENRTL button of the command window 410 is selected. The user may select and execute the GENRTL button while a clock diagram of a clock management unit under design is displayed on the design window 440, and may also verify in advance whether there is an error in the clock diagram by executing the check button before executing the GENRTL button.

The clock module generator 341 converts information on a designed clock instance in accordance with the hardware code logic stored in the hardware code logic storage 334 to generate a clock module. The port type of the clock module and a hierarchical structure of a hardware module may be determined according to the configuration of the designed clock instance.

The register module generator 342 generates a register module according to the hardware code logic on the basis of register field values of the designed clock instance, and ports of a register module corresponding to ports of the clock module may be created. For example, a clock divider module may include a division ratio port, a busy port, and a debug port, and a division ratio port, a busy port, and a debug port may be generated for a register module related to the clock divider module.

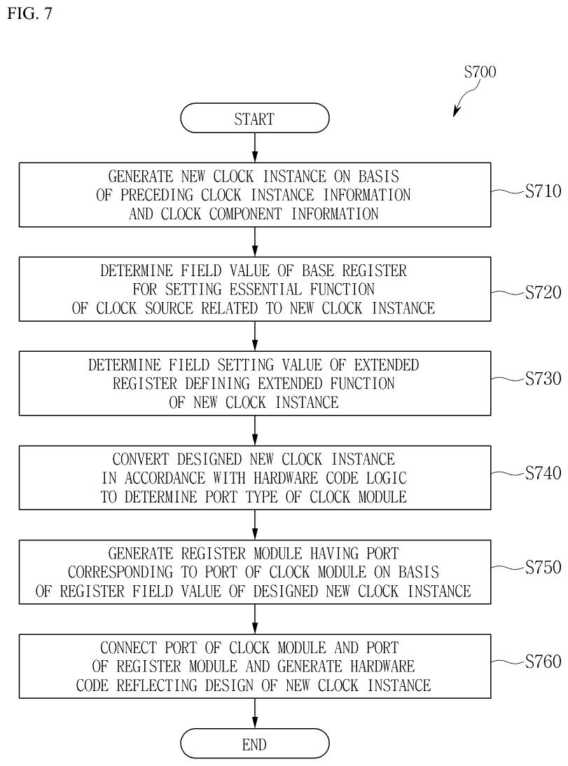

The hardware code generator 343 automatically connects the ports of the clock module and the ports of the register module related to the clock module according to the hardware code logic, and generates hardware code (RTL code) in which the setting values of the clock instance have been reflected. FIG. 7 is an operation flowchart illustrating a clock element no-code design method according to the present disclosure. The clock element no-code design method according to the present disclosure may be executed by a processor of a computer system.

The computer system includes a clock component storage in which clock component information for defining register addresses and field values of clock instances generated on the basis of clock components is stored, and a hardware code logic storage in which hardware code logic for generating a designed clock instance as hardware code.

The processor designs a new clock instance by setting field values of registers defining the functions of the new clock instance on the basis of information on previously generated clock instances and the clock component information.

The process of designing a new clock instance by the processor is described in detail. The processor generates a new clock instance on the basis of information on previously generated clock instances and the clock component information and stores the new clock instance in the clock instance storage (S710), determines field values of a base register for setting essential functions of a clock source related to the new clock instance and stores the same in the clock instance storage (S720), and determines setting values of fields of an extended register defining extended functions of the new clock instance and stores the same in the clock instance storage (S730).

Next, the processor generates a clock module and a register module related to the clock module on the basis of the field values of the register of the designed new clock instance and the hardware code logic, and generates hardware code by combining the clock module and the register module.

The process of generating hardware code by the processor is described in detail. The processor converts the designed new clock instance in accordance with the hardware code logic to determine the port type of the clock module (S740), generates a register module including ports corresponding to the ports of the clock module on the basis of the register field values of the designed new clock instance (S750), connects the ports of the clock module and the ports of the register module, and generates hardware code reflecting the design of the new clock instance (S760).

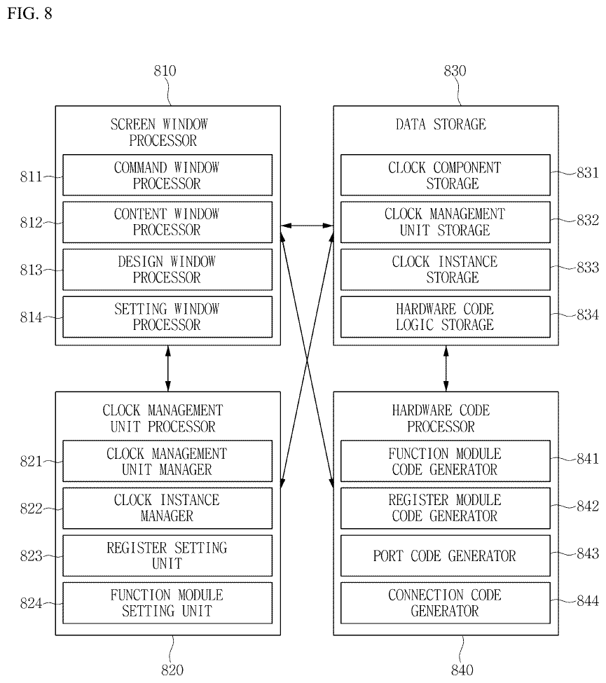

FIG. 8 is a configuration diagram of a no-code type clock management unit design system according to an embodiment of the present disclosure. The no-code type clock management unit design system according to the present disclosure may be implemented as a computer system.

The no-code type clock management unit design system according to the present disclosure may include a screen window processor 810 that detects a user input and outputs a processing result for the user input on a display screen, a clock management unit processor 820 that generates one or more clock instances on the basis of clock component information and designs a clock management unit by generating a connection between any two clock instances, a data storage 830 in which hardware code logic for generating hardware code on the basis of clock component information and information on a designed clock management unit is stored, and a hardware code processor 840 that generates hardware code related to the information on the designed clock management unit using the hardware code logic.

When auto clock gating of the clock management unit is set, auto clock gating may be used for all connections between clock instances constituting the clock management unit. Auto clock gating of the clock management unit means an auto clock gating function between clock instances constituting the clock management unit.

Referring back to FIG. 4, the setting window 450 may provide an auto clock gating (ACG) setting environment of a clock management unit under design and a function setting environment for a clock instance selected on the design window 440. When auto clock gating of the clock management unit under design is enabled, auto clock gating may be applied to all connectors between any two clock instances constituting the clock management unit under design. Only a clock line is connected to the any two clock instances if auto clock gating is not applied between the two clock instances, and a clock line and a handshake signal line are connected to the two clock instances if auto clock gating is applied between the two clock instances.

The screen window processor 810 may include a command window processor 811 that displays buttons for receiving user commands on the command window 410, detects an input applied to each button on the command window 410, and causes an operation related to the input button to be performed, a content window processor 812 that hierarchically displays a list of clock management units under design, a list of clock instances included in each clock management unit under design, and register information on the content window 430, detects user input applied to the content window 430, and causes an operation related to the user input to be performed, a design window processor 813 that displays a clock diagram of a clock management unit under design selected by the user on the design window 440, detects user input applied to the design window 440, and causes an operation related to the user input to be performed, and a setting window processor 814 that displays auto clock gating setting information of the clock management unit under design selected by the user and configuration information of a clock instance selected by the user on the setting window 450, detects user input applied to the setting window 450, and causes an operation related to the user input to be performed.

When the CHECK button is selected, the command window processor 811 performs an operation of checking errors in a clock diagram of a clock management unit under design, setting values of clock instances constituting the clock management unit under design, and connections between parent and child clock instances, and causes a part where an error has occurred to be displayed. When the UNCHECK button is selected, the command window processor 811 restores the error part displayed in the clock diagram of the clock management unit under design to its original state and displays the same. When the SAVE button is selected, the command window processor 811 saves the details of work for the clock management unit under design displayed on the design window 440 in the content data storage 830. When the GENRTL button is selected, the command window processor 811 generates hardware code for the clock diagram of the clock management unit under design displayed on the design window 440.

The content window processor 812 provides an environment for adding, deleting, and changing a list of clock management units under design and a list of clock instances included in each clock management unit under design. The content window processor 812 may hierarchically display a clock instance list, base register information related to basic functions of each clock instance, and optionally extended register information according to extended functions under each clock management unit under design. The user may add, delete, and rename a clock management unit under design in the content window 430, a list of clock management units under design is added, deleted, and changed in response to user input in the clock management unit storage 832, and auto clock gating of each clock management unit may set. When the user changes the name of a clock management unit under design, the content window processor 812 may cause not only the name of the clock management unit under design but also the names of clock instances under the clock management unit under design and the base register names and extended register names of the clock instances to be changed at once.

The design window processor 813 displays a clock diagram of a clock management unit under design in the design window 440 and provides an environment for adding, deleting, and changing clock instances that constitute the clock management unit under design. When the user performs an operation of adding an arbitrary clock component on the clock component window 420 to the design window 440, the design window processor 813 detects the user operation and causes a clock instance addition operation to be performed.

The setting window processor 814 displays auto clock gating (ACG) setting information of the clock management unit under design, detects user input in the setting window 450, and causes an operation related to the user input to be performed. That is, auto clock gating of the clock management unit under design may be set or setting may be canceled according to user input. In addition, the setting window processor 814 displays extended function configuration information of a clock instance selected by the user in the setting window 450, detects user input applied to the setting window 450, and causes an operation related to the user input to be performed. The setting window processor 814 may set or cancel the extended function of the clock instance according to user input.

The data storage 830 may include a clock component storage 831 in which clock component information is stored, a clock management unit storage 832 in which auto clock gating (ACG) setting information of a clock management unit under design, a list of clock instances included in the clock management unit under design, and a register list related to the clock instances are stored, a clock instance storage 833 in which basic function information and extended function information of individual clock instances included in the clock management unit under design and register information of the individual clock instances are stored, and a hardware code logic storage 834 in which hardware code logic for generating hardware code on the basis of the auto clock gating setting information of the clock management unit under design, basic function information and extended function information of designed clock instances, and register information is stored. The register list related to the clock instances may include a base register list and an extended register list.

The clock component information stored in the clock component storage 831 may include a register address range allocated to each clock component, an alignment size of each clock component, a base register offset size for each clock component, an extended register offset size for each clock component, and configuration field information (field name, bit position, bit size, access permission, initial value, etc.) for each clock component. The clock component information defines a register address and field value of a clock instance generated on the basis of the relevant clock component. Information on the maximum number of clock instances for each clock component may be calculated using the register address range allocated to each clock component and the alignment size of each clock component. Clock components may include a PLL controller component, a clock divider component, a clock multiplexer component, and a clock gate component. A clock component may include a basic function module for performing a basic function of the clock component and an extended function module for performing an extended function of the clock component. When a clock instance related to a clock component is generated, the basic function module is enabled, and when the user sets an extended function of the clock instance through the setting window 450, an extended function module related to the set extended function may be enabled. Respective clock components may have different basic function modules and extended function modules.

The clock component storage 831 stores configuration field information (field name, bit position, bit size, access permission, initial value, etc.) for each individual clock component. This configuration field information may be different for each individual clock component type. Here, the bit position is a start address of the relevant field among the addresses allocated to an individual clock instance, the bit size is the range of the relevant field, the access permission is the presence or absence of write permission (read only/read write) for the relevant field, and the initial value is an initial setting value.

The PLL controller component may include a SELECT field, a BUSY field, and a debug (DBG_INFO) field as base register information and include a power-down (DWRDOWN) field and a custom (CUSTOM) field as extended register information, and the field name, bit position, bit size, access permission, and initial value of each field may be set. Here, the SELECT field is a field for selecting a PLL type, the BUSY field is a field for monitoring whether the clock element is operating, and the debug field is a field for storing debugging information. The PLL controller component may further include an auto clock gating field that is enabled when auto clock gating of the clock management unit is set.

The clock multiplexer component may include a SELECT field, a BUSY field, and a debug (DBG_INFO) field as base register information and include a THROTTLE field and a CUSTOM field as extended register information. The field name, bit position, bit size, access permission, and initial value of each field are set. Here, the SELECT field is a field for selecting the number of multiplexer inputs, the BUSY field is a field for monitoring whether the clock element is operating, and the DEBUG field is a field for storing debugging information. The clock multiplexer component may further include an auto clock gating field that is enabled when auto clock gating of the clock management unit is set.

The clock divider component may include a division ratio (DIVRATIO) field, a BUSY field, and a debug (DBG_INFO) field as base register information and include a power-down (DWRDOWN) field, a THROTTLE field, and a CUSTOM field as extended register information. The field name, bit position, bit size, access permission, and initial value of each field are set. The division ratio field is a field for setting a division ratio of a clock divider, the busy field is a field for monitoring whether the clock element is operating, and the debug field is a field that stores debugging information. The clock divider component may further include an auto clock gating field that is enabled when auto clock gating of the clock management unit is set.

The clock gate component may include a BUSY field and a debug (DBG_INFO) field as base register information and include an ENABLE field, a SHORTSTOP field, an early wakeup (EWAKEUP) field, and a CUSTOM field as extended register information. The field name, bit position, bit size, access permission, and initial value of each field are set. The busy field is a field for monitoring whether the clock element is operating, and the debug field is a field that stores debugging information. The clock gate component may further include an auto clock gating field that is enabled when auto clock gating of the clock management unit is set.

The power-down (DWRDOWN) field is a field for determining whether to use a function of controlling the relevant clock element while a power up/down sequence of any power domain is in operation. The PLL controller instance and the clock multiplexer instance support an operation feature of forcing the output value to be overridden as 0 if the power-down field is set to a specific value, and the clock divider instance supports an operation feature of forcing the output value to be output as a low level if the power-down field is set to a specific value.

The THROTTLE field is a field for determining a feature of decreasing temperature by lowering the clock frequency momentarily when the temperature of the clock element increases above a certain level. The clock multiplexer instance and the clock divider instance support an operation feature of forcing the division ratio and output frequency to be changed when a throttle signal is input if the THROTTLE field is set to a specific value.

The CUSTOM field is a field for determining the function of controlling the relevant clock element through separate custom hardware. The SHORTSTOP field supports an operation of stopping several cycles before and after a period in which a signal changes from 0 to 1 or 1 to 0. The SHORTSTOP field may be set in the clock gate instance. The EWAKEUP field is a field for receiving a signal from outside the clock management unit to determine whether to enable auto clock gating between a clock element and an IP block.

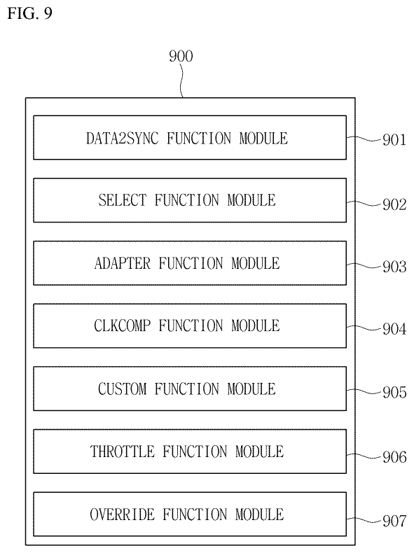

FIG. 9 is a block diagram showing internal function modules of a clock multiplexer component according to the present disclosure. The clock multiplexer component 900 may include a DATA2SYNC function module 901, a SELECT function module 902, an ADAPTER function module 903, and a CLKCOMP function module 904 as basic function modules. The clock multiplexer component 900 may include a CUSTOM function module 905, a THROTTLE function module 906, and an OVERRIDE function module 907 as extended function modules.

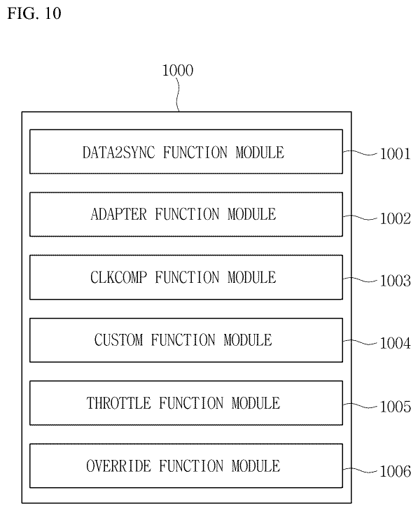

FIG. 10 is a block diagram showing internal function modules of a clock divider component according to the present disclosure. The clock divider component 1000 may include a DATA2SYNC function module 1001, an ADAPTER function module 1002, and a CLKCOMP function module 1003 as basic function modules. The clock divider component 1000 may include a CUSTOM function module 1004, a THROTTLE function module 1005, and an OVERRIDE function module 1006 as extended function modules.

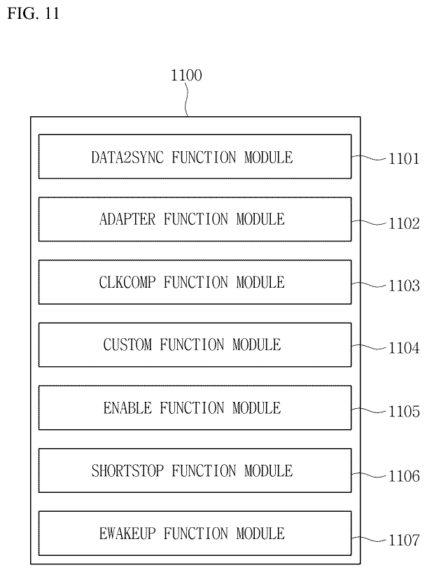

FIG. 11 is a block diagram showing internal function modules of a clock gate component according to the present disclosure. The clock gate component 1100 may include a DATA2SYNC function module 1101, an ADAPTER function module 1102, and a CLKCOMP function module 1103 as basic function modules. The clock gate component 1100 may include a CUSTOM function module 1104, an ENABLE function module 1105, a SHORTSTOP function module 1106, and an EWAKEUP function module 1107 as extended function modules.

The DATA2SYNC function modules 901, 1001, and 1101 execute a function of synchronizing a control signal of a clock control circuit of a clock element and a clock signal of a clock source, and the CLKCOMP function modules 904, 1003, and 1103 execute a function of processing a clock signal received from a parent clock source and then transferring the same to a child clock source. The ADAPTER function modules 903, 1002, and 1102 are enabled when auto clock gating of the clock management unit is set, and execute a function of operating a handshake signal line connected to a parent clock control circuit and operating a handshake signal line connected to a child clock control circuit.

The SELECT function module 902 executes a function of selecting the number of multiplexer inputs according to the setting value of the SELECT field, and the CUSTOM function modules 905, 1004, and 1104 are enabled according to the setting value of the CUSTOM field and execute a function of controlling the relevant clock element through separate custom hardware. The THROTTLE function modules 906 and 1005 are enabled according to the setting value of the THROTTLE field and execute a function of momentarily lowering the clock frequency when the temperature of the clock element increases above a certain level. In addition, the OVERRIDE function modules 907 and 1006 are enabled according to the setting value of the power down field and execute a function of forcibly setting the output value to 0. The SHORTSTOP function module 1106 is enabled according to the setting value of the SHORTSTOP field and executes a function of stopping several cycles before and after a period in which a signal changes from 0 to 1 or from 1 to 0, and the EWAKEUP function module 1107 is enabled according to the setting value of the EWAKEUP field and executes the auto clock gating function with an IP block by receiving a signal from outside the clock management unit.

The clock management unit storage 832 stores auto clock gating (ACG) setting information of a clock management unit under design, a list of clock instances included in the clock management unit under design, and a register list related to the clock instances.

The clock instance storage 833 stores clock instance information, extended function information, and register information of clock instances with respect to clock instances included in a clock management unit under design. The clock instance storage 833 may store the name of a clock management unit under design, the clock component types of clock instances, the start address of a relevant clock instance, basic function modules of the clock instance and adapter function modules enabled in response to auto clock gating setting, an extended function module enabled in response to an extended function of the clock instance set by the user, and setting values of each register field. The setting values of each register field may be set on the basis of clock component information or may be set by reflecting user input. In addition, port information for connecting registers to basic function modules and extended function modules for the clock instance, handshake signal line information for connecting the adapter function module to a parent clock instance and a child clock instance, and clock line information may be further stored in the clock instance storage 833.

The hardware code logic storage 834 stores hardware code logic for generating hardware code on the basis of information on a designed clock management unit, auto clock gating setting information of the clock management unit, clock instance information, and register information.

The clock management unit processor 820 may include a clock management unit manager 821 that generates a clock management unit and stores auto clock gating setting information of the clock management unit in the clock management unit storage 832, a clock instance manager 822 that generates a new clock instance on the basis of information on a previously generated clock instance of the same clock component type and clock component information and stores the same in the clock instance storage 833, a register setting unit 823 that sets field values of a base register defining basic functions of the new clock instance and field values of an extended register defining extended functions of the new clock instance and stores the same in the clock instance storage 833, and a function module setting unit 824 that enables basic function modules for performing the basic functions of the new clock instance, extended function modules for performing the extended functions of the new clock instance, and an adapter function module according to an auto clock gating setting of the clock management unit.

The clock management unit manager 821 allows the user to operate the content window 430 to generate a new clock management unit and store the same in the clock management unit storage 832 or to load a clock management unit under design, which has been generated and displayed in the content window 430, from the clock management unit storage 832 and change the same. When a new clock management unit or a clock management unit under design is selected, an auto clock gating setting screen of the clock management unit is displayed in the setting window 450, and an auto clock gating setting value according to user operation may be stored in the clock management unit storage 832. In addition, when a clock management unit is selected, a clock diagram of the clock management unit is displayed in the design window 440, and the clock diagram of the clock management unit may be changed. In other words, a clock instance may be added to, deleted from, or changed in the clock management unit.

The clock instance manager 822 may be executed when the user adds any clock component on the clock component window 420 to the design window 440 to generate a new clock instance. The name of the new clock instance may include the name of the clock management unit under design including the new clock instance and clock component type information of the new clock instance. In addition, the address of the new clock instance may be set on the basis of information on a previously generated clock instance of the same clock component type and clock component information. That is, the start address of the register of the new clock component may be determined by adding the start address of the register of the previously generated clock instance to the alignment size of the clock component information, and initial setting values of register fields may be determined on the basis of the base register offset size, the extended register offset size, and configuration field information of the clock component information.

The field name, bit position, bit size, access permission, and initial values of a configuration field included in a base register of a clock instance may be displayed on the design window 440 or the setting window 450 by the register setting unit 823 and may be changed according to user input. The base register sets the essential functions of the clock source of the clock element. That is, for the PLL controller instance, a PLL type selection function, a clock element operation monitoring function, a debugging function, etc. may be set, and setting values of register fields related to each function may be set. For the clock multiplexer instance, a multiplexer input number selection function, a clock element operation monitoring function, a debugging function, etc. may be set, and setting values of register fields related to each function may be set. For the clock divider instance, a division ratio function, a clock element operation monitoring function, a debugging function, etc. may be set, and setting values of register fields related to each function may be set. For the clock gate instance, a clock element operation monitoring function, a debugging function, etc. may be set, and values of register fields related to each function may be set.

In addition, the register setting unit 823 may display extended functions that can be set for each clock component on the screen, and when the user selects an extended function, set the field of an extended register related to the extended function. For the PLL controller instance, the power-down (DWRDOWN) function, the CUSTOM function, etc. may be selected, and a value of an extended register field related to an extended function selected by the user may be set. For the clock multiplexer instance, the THROTTLE function, the CUSTOM function, etc. may be selected, and a value of an extended register field related to an extended function selected by the user may be set. For the clock divider instance, the power-down (DWRDOWN) function, the THROTTLE function, the CUSTOM function, etc. may be selected, and a value of an extended register field related to an extended function selected by the user may be set. For the clock gate instance, the SHORTSTOP function, the ENABLE function, the EWAKEUP function, the CUSTOM function, etc. may be selected, and a value of an extended register field related to an extended function selected by the user may be set.

The function module setting unit 824 sets function modules such that basic function modules are enabled and extended function modules for performing extended functions set in the register setting unit 823 are enabled for each clock instance. That is, a clock component includes a basic function module for performing the basic function of the clock component and an extended function module related to each of all extended functions that can be set in the clock component, and accordingly, a clock instance generated on the basis of the clock component also includes both the basic function module and the extended function module. However, depending on an extended function setting value of the user, the relevant extended function module may be enabled or disabled.

In addition, a clock component includes an adapter function module for performing auto clock gating, and a clock instance generated on the basis of the clock component also includes the adapter function module. However, depending on whether auto clock gating of the clock management unit is set, the adapter function module of each clock instance may be enabled or disabled. The function module setting unit 824 enables the adapter function module when auto clock gating of the clock management unit is set by the clock management unit manager 821.

The hardware code processor 840 may include a function module code generator 841 that generates hardware code related to a function module of a designed clock element on the basis of information on the designed clock instance, a register module code generator 842 that generates hardware code of a register module for driving the function module of the clock element, a port code generator 843 that generates hardware code of ports connecting the function module of the clock element and the register module, and a connection code generator 844 that generates hardware code of a connection between the clock element and at least one of a parent clock element and a child clock element.

The hardware code processor 840 may be executed when the GENRTL button on the command window 410 is selected. The user may select and execute the GENRTL button while a clock diagram of a clock management unit under design is displayed on the design window 440, and may also verify in advance whether there is an error in the clock diagram by executing the CHECK button before executing the GENRTL button.

The function module code generator 841 converts designed clock instance information in accordance with the hardware code logic stored in the hardware code logic storage 834 to generate hardware code of a function module. The basic function module is necessarily enabled for each clock instance, the extended function module may be further enabled according to setting of the extended function of the clock instance, and hardware code may be generated for the enabled basic function module and extended function module.

The register module code generator 842 may generate hardware code of a register module according to the hardware code logic on the basis of register field values of a designed clock instance. In response to the enabled basic function module and extended function module of the clock element, hardware code of register modules that control the operations of the basic function module and the extended function module may be generated.

The port code generator 843 may generate hardware code of ports for connecting an enabled basic function module and extended function module to register modules related thereto. The port code generator 843 may generate hardware code of a port for communicating with an enabled extension function module and a register module, and may not generate hardware code of a port for communicating with a disabled extension function module and a register module. For example, a clock divider module may include a division ratio port, a busy port, and a debug port, and a division ratio port, a busy port, and a debugger port may be generated for a register module related to the clock divider module.

The connection code generator 844 may generate hardware code of a clock line of a clock element. The clock line of the clock element may be connected to a parent clock element or may be connected to a child clock element. In addition, the connection code generator 844 may further generate hardware code of a handshake signal line of the clock element. The handshake signal line of the clock element may be connected to a parent clock element or may be connected to a child clock element.

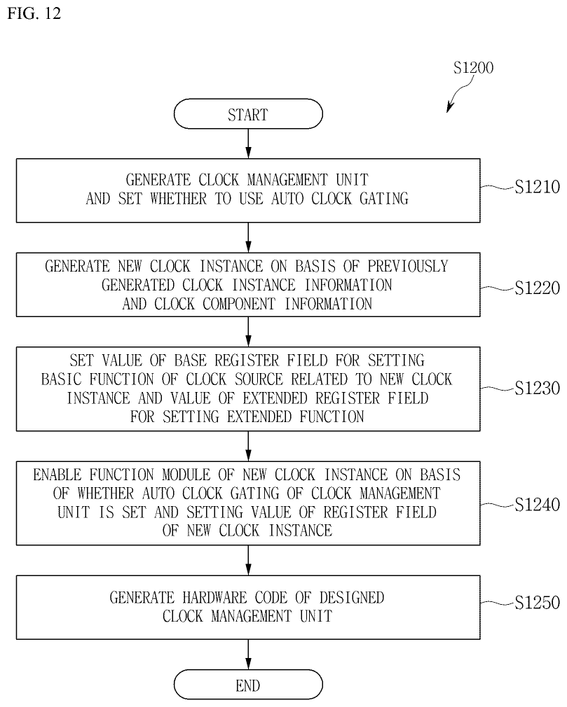

FIG. 12 is an operation flowchart illustrating a no-code type clock management unit design method according to the present disclosure. The no-code type clock management unit design method according to the present disclosure may be executed by a processor of a computer system. The computer system includes a clock component storage in which clock component information for defining a register address and a field value of a clock instance generated on the basis of a clock component is stored, and a hardware code logic storage in which hardware code logic for generating a designed clock management unit as hardware code is stored.

The processor generates a clock management unit and sets whether to set auto clock gating of the clock management unit (S1201). The processor stores information on the generated clock management unit in the clock management unit storage 832. The processor designs a new clock instance by setting field values of registers that define the functions of the new clock instance on the basis of information on a previously generated clock instance and the clock component information.

The process of designing a new clock instance by the processor is described in detail. The processor generates a new clock instance on the basis of information on a previously generated clock instance and the clock component information and stores the same in the clock instance storage (S1220), sets values of base register fields for setting basic functions of a clock source related to the new clock instance and values of register fields for setting extended functions of the new clock instance, and stores the same in the clock instance storage (S1230).

The processor enables function modules of the new clock instance on the basis of whether auto clock gating of a clock management unit is set and the setting values of the register fields of the new clock instance (S1240). That is, the processor enables basic function modules for performing the basic functions of the new clock instance, and enables extended function modules for performing extended functions when the field values of the extended registers for setting the extended functions of the new clock instance are set to specific values. In addition, when auto clock gating of the clock management unit is set, the adapter function module for performing auto clock gating is enabled.

The processor generates hardware code of a clock management unit designed on the basis of the setting values of the register fields of the new clock instance, the enabled function module information of the new clock instance, and the hardware code logic (S1250). That is, hardware code for an enabled function module, hardware code of a register module for operating the enabled function module, hardware code of a port for connecting the register module and enabled activated function module, and hardware code for a connection are generated.

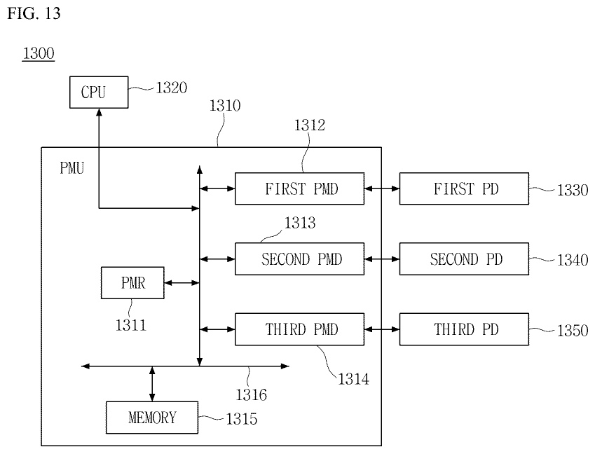

FIG. 13 is a configuration diagram of a system-on-chip (SoC) to be designed according to the present disclosure. The SoC 1300 is a single integrated circuit in which a fully operated product and system are mounted, and may be implemented as a chip, a module, or a system. The SoC 1300 may include a power management unit (PMU) 1310, a central processing unit (CPU) 1320 that controls the power management unit 1310 using software, and at least one power domain (PD) 1330, 1340, and 1350. The central processing unit 1320 controls the power management unit 1310 and may be one power domain that constitutes the SoC device. That is, the central processing unit 1320 and the first power domain 1330 may be the same component.

The power management unit 1310 may provide a power up/down sequence for each of the one or more power domains 1330, 1340, and 1350. Each of the power domains 1330, 1340, and 1350 may process the power up/down sequence to become a power up state or a power down state. The SoC device may include at least one power management unit 1310.

The power domains may include a core domain including the central processing unit 1320, a memory domain including a memory subsystem such as a main memory or a cache memory, a graphics and video domain including multimedia elements such as a graphics processing unit or a video encoding/decoding device, and an input/output domain including an input/output interface element for communication with the outside. Each power domain may include a sub-power domain.

The power management unit 1310 may include at least one domain power manager (PMD; Power Management for Domain) 1312, 1313, and 1314 that relates to each of the power domains 1330, 1340, and 1350 and controls the power domain 1330, 1340, and 1350 related thereto, a root power manager (PMR; Power Management for Root) 1311 that manages the at least one domain power manager 1312, 1313, and 1314, and a memory 1315 that stores a program for operating the root power manager 1311 and the at least one domain power manager 1312, 1313, and 1314. At least one domain power manager 1312, 1313, and 1314, the root power manager 1311, and the memory 1315 may be interconnected by an internal bus 1316. The program stored in the memory 1315 may include instructions and data.

The root power manager 1311 may receive a system power up/down command from the central processing unit 1320. The system power up/down command may include a power up/down command for the SoC device or a power up/down command for a subsystem composed of one or more power domains. The power up/down command of the SoC device and the power up/down command of the subsystem may be collectively referred to as a system power up/down command.

The root power manager 1311 may perform booting of the SoC device 1300 by operating at least one domain power manager 1312, 1313, and 1314 on the basis of an instruction and data for performing booting at the time of booting. In addition, when a system power up/down command is received from the central processing unit 1320, the root power manager 1311 may turn on/off the power of the SoC device 1300 or the subsystem composed of multiple power domains by operating at least one domain power manager 1312, 1313, and 1314 on the basis of an instruction and data for performing the command.

Upon receiving a domain power up/down command for power control of a power domain from the central processing unit 120, at least one domain power manager 1312, 1313, and 1314 may perform power up/down sequence control on the relevant power domain on the basis of an instruction and data for performing the command.

The first domain power manager 1312 may output a power control signal to the first power domain 1330 and perform a power up/down sequence, the second domain power manager 1313 may output a power control signal to the second power domain 1340 and perform a power up/down sequence, and the third domain power manager 1314 may output a power control signal to the third power domain 1350 and perform a power up/down sequence. That is, since separate domain power managers 1312, 1313, and 1314 are matched to the power domains 1330, 1340, and 1350 and thus power control of the power domains 1330, 1340, and 1350 can be performed in parallel, efficient and fast processing can be achieved.

The root power manager 1311, the first domain power manager 1312, the second domain power manager 1313, and the third domain power manager 1314 may each be implemented as a programmable sequencer. The memory 1315 may store instructions and data for the root power manager 1311 to perform a system power up/down command as binary code and may store instructions and data for each domain power manager 1312, 1313, and 1314 to perform a domain power up/down command as binary code.

Although an SoC device composed of three power domains and three domain power managers is illustrated in FIG. 13, the number of power domains may be designed to be a different number depending on the complexity of the SoC device, and the number of domain power managers may be changed depending on the number of power domains. The root power manager 1311 and the domain power managers 1312, 1313, and 1314 may be programmable sequencers implemented as microprocessing units (MCUs).

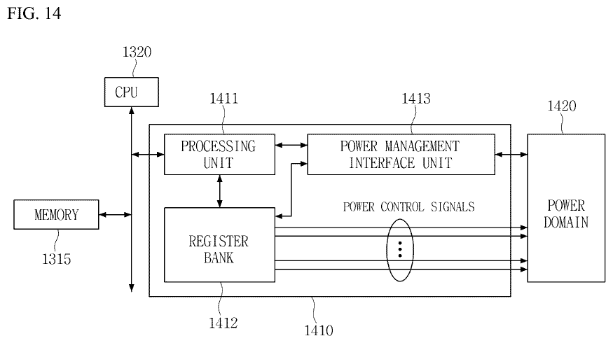

FIG. 14 is a configuration diagram of the domain power manager 1410 of FIG. 13. The domain power manager 1410 may be an example of a programmable sequencer. The domain power manager 1410 transmits power control signals to the power domain 1420 and performs a power up/down sequence of the power domain 1420 such that transition from a power up state to a power down state or from a power down state to a power up state occurs. The power control signals for performing the power up/down sequence may include a reset signal, an isolation signal, a switch control signal, and a retention signal. These power control signals may be added/deleted/changed according to the specifications of the power domain 1420.

The domain power manager 1410 of FIG. 14 may be one of the first domain power manager 1312, the second domain power manager 1313, and the third domain power manager 1314 of FIG. 13. The power domain 1420 of FIG. 14 may be one of the power domains 1320, 1330, and 1340 of FIG. 13. When designing a domain power manager, binary code of a program including instructions and data to be performed by the domain power manager 1410 may be stored in the memory 1315, and the central processing unit 1320 may change the program including instructions and data to be performed by the domain power manager 1410 stored in the memory 1315.

The central processing unit 1320 outputs a domain power up/down command for power control of the power domain 1420 to the domain power manager 1410. Upon receiving the domain power up/down command, the domain power manager 1410 transmits power control signals to the power domain 1420 to perform a power up/down sequence. Accordingly, transition of the power domain 1420 to a power up state or a power down state occurs.

The domain power manager 1410 includes a processing unit 1411 that receives a domain power up/down command related to power control of the power domain 1420 from the central processing unit 1320, accesses the memory 1315 in which an instruction for performing the command is stored, and executes the instruction stored in the memory 1315, and a register bank 1412 having at least one field value that is changed by the processing unit 1411 such that power control signals are transmitted to the power domain 1420. The processing unit 1411 may include a plurality of power elements, and each power element may be related to one of the power control signals.

The processing unit may include at least one of a power element for transmitting a reset signal to a power domain, a power element for transmitting an isolation signal to a power domain, a power element for transmitting a switch control signal to the power domain, a power element for transmitting a retention signal to the power domain, a power element capable of automatically performing power up/down by a trigger signal of hardware, a power element for gating a reference clock supplied to the power domain, a power element for generating a power control signal for a memory of the power domain, a power element for generating a handshake control signal with respect to the power domain, a power element for generating a link control signal with respect to a clock management unit, a power element for generating a P-channel handshake control signal with respect to the power domain, a power element for generating a user-defined output signal within the power domain, and a power element for generating a user-defined input signal within the power domain. Such power elements constituting the processing unit may be configured by generating power instances through the design system of the present disclosure and generating hardware code on the basis of the power instances.

The register bank 1412 may include a plurality of register fields corresponding to power elements constituting the processing unit. A power element responsible for transmitting/receiving a power control signal to/from a power domain may change the value of a relevant register field, and the values recorded in the register field may be transmitted to the power domain 1420 as a power control signal. For example, the power element for transmitting a reset signal may change the value of a register field related to the reset signal in the register bank 1412 to 0 or 1, and at this time, 0 or 1 may be transmitted to a reset port of the power domain. In addition, the power element for transmitting an isolation signal may change the value of a register field related to the isolation signal in the register bank 1412 to 0 or 1, and at this time, 0 or 1 may be transmitted to an isolation port of the power domain. Similarly, the power element related to a switch control signal or a retention signal may change the value of a register field related to the switch control signal or the retention signal in the register bank 1412 to 0 or 1, and at this time, 0 or 1 may be transmitted to a switch control port or a retention port of the power domain. For the operation of the processing unit, register field addresses that are instruction execution targets may be additionally stored in the memory 1315 together with instructions and data.

The instructions stored in the memory 1315 include an instruction to write a specific register field value of the register bank 1412 as 0 and an instruction to write a specific field value of the register bank 1412 as 1. The processing unit 1411 may execute the instruction to change the specific register field value of the register bank 1412 to 0 or 1. Then, the value of the relevant power control signal is changed to 0 or 1 and transmitted to the power domain 1420.

The domain power manager 1410 may further include a power management interface unit 1413 that receives a signal from the power domain 1420 and transmits the same to at least one of the processing unit 1411 and the register bank 1412. Power control signals include a lot of signals that are formed by a handshake. For example, after transmitting a power switch enable signal, it is necessary to wait until a feedback signal in response to the power switching enable signal is received. At this time, the feedback signal output from the power domain is recorded as a specific register field value of the register bank 1412 through the power management interface unit 1413, and the processing unit 1411 waits until a specific value is recorded as the register field value. To this end, the instructions stored in the memory 1315 may include an instruction to wait until a specific register field value of the register bank 1412 becomes 0, and an instruction to wait until a specific register field value of the register bank 1412 becomes 1.

In addition, it may be necessary to wait for a certain period of time or more after transmitting one of the power control signals before performing the next operation. For example, when the power domain 1420 is reset and released, it is necessary to wait until the power domain 1420 is reset and operates normally.

To this end, the instructions stored in the memory 1315 may include an instruction to wait for a specific cycle time, and waiting time information may be stored in a specific register field of the register bank 1412, or a user-input constant value may be stored in an internal register of the processing unit.

In addition, the instructions stored in the memory 1315 may include an instruction to write an internal register value of the processing unit 1411 to a specific register field of the register bank 1412, an instruction to write a specific register field value of the register bank 1412 to an internal register of the processing unit 1411, and an instruction to write a user-input constant value to an internal register of the processing unit 1411.

In addition, the instructions stored in the memory 1315 may include instructions to determine the execution order of the instructions stored in the memory 1315, and such instructions may include an instruction to jump to a specific address, an instruction to return to a previous address, and an instruction to move to a specific address according to a result of executing an instruction.

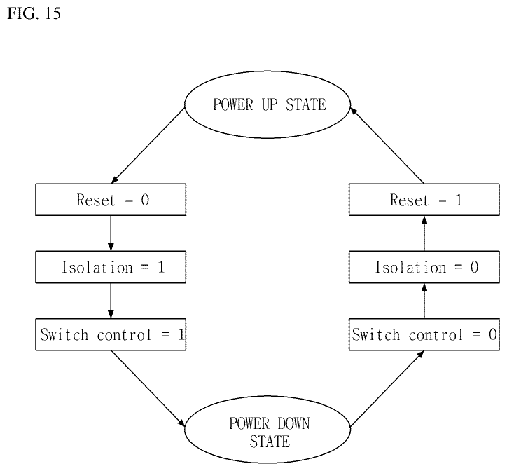

FIG. 15 is a power state transition diagram of a power domain according to the present disclosure. It is assumed that the power domain 1420 enters a power-down state if transition of a reset signal from 1 to 0, transition of an isolation signal from 0 to 1, and transition of a switch control signal from 0 to 1 occur when the power domain 1420 is in a power-up state. Power control signals that cause the power domain 1420 in a power-up state to enter a power-down state are referred to as a power-down sequence. In addition, it is assumed that the power domain 1420 enters a power-up state if transition of the switch control signal from 1 to 0, transition of the isolation signal from 1 to 0, and transition of the reset signal from 0 to 1 occur when the power domain 1420 is in a power-down state. Power control signals that cause the power domain 1420 in a power-down state to enter a power-up state are referred to as a power-up sequence.

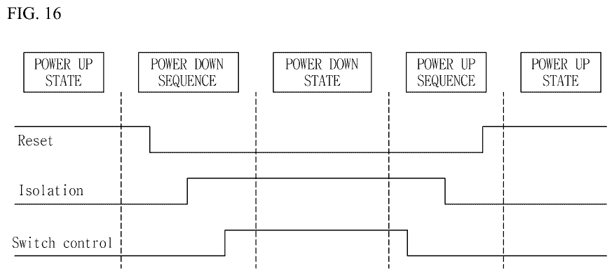

FIG. 16 is a diagram showing an example of a power-up sequence and a power-down sequence performed by a domain power manager according to the present disclosure. The domain power manager 1410 performs a power-up sequence and a power-down sequence on the power domain 1420, and transition of the power domain 1420 to a power-up state and a power-down state may occur according to execution of the power-up sequence and the power-down sequence.

In a state where the domain power manager 1410 stores instructions for controlling power of the power domain 1420 in the memory 1315, the central processing unit 1320 transmits a domain power-up command or a domain power-down command to the domain power manager 1410.

Upon receiving the domain power-down command from the central processing unit 1320, the domain power manager 1410 reads instructions to perform a power-down sequence on the power domain 1420 from the memory 1315 and executes the same. Such instructions include instructions to set a specific register field value of the register bank 1412 to 0 or 1, and by executing these instructions, the power-down sequence may be performed on the power domain 1420 as illustrated in FIG. 16.

Meanwhile, when the domain power-up command is received from the central processing unit 1320, the domain power manager 1410 reads instructions to perform a power-up sequence on the power domain 1420 from the memory 1315 and executes the same, and accordingly, the power-up sequence may be performed on the power domain 1420 as illustrated in FIG. 16.

If at least parts of the power-down sequence and power-up sequence are changed, the central processing unit 1320 may change the execution order of instructions and data stored in the memory 1315. If the execution order of the instructions and data stored in the memory 1315 are changed in this manner, the domain power manager 1410 that receives the subsequent domain power-up command or domain power-down command performs the power up/down sequence by reflecting the changed instruction execution order and data. In this manner, the domain power manager 1410 operates as a programmable sequencer.

Similarly to the domain power manager described above, the root power manager may be implemented as a programmable sequencer. A program including instructions and data to be performed by the root power manager may be stored in the memory. The central processing unit may change and store the program including the instructions and data stored in the memory. The central processing unit may output a system power up/down command to the root power manager. The system power up/down command may include a power up/down command for an SoC device or a power up/down command for any subsystem composed of multiple power domains.

The memory stores instructions that need to be executed by the root power manager according to the system power up/down command, and when the system power up/down command is received from the central processing unit, the root power manager executes the instructions stored in the memory and transmits a power control signal to at least one domain power manager to control power. Accordingly, an SoC device or a subsystem composed of multiple power domains can be powered on/off.

The memory stores a program including instructions and data for domain power up/down and system power up/down, and the program stored in the memory may be executed by the domain power manager and/or the root power manager implemented as programmable sequencers. Therefore, it is necessary to design the programmable sequencer such that it can operate as the domain power manager or the root power manager.

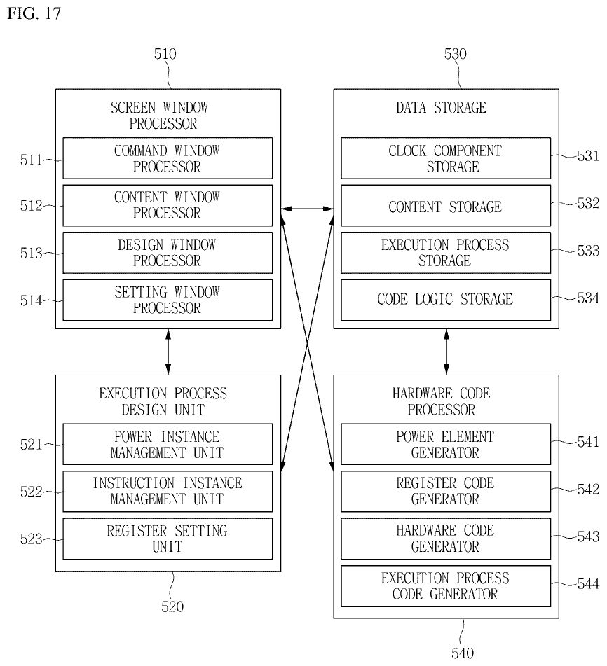

FIG. 17 is a diagram showing a no-code type programmable sequencer design system according to the present disclosure. The programmable sequencer design system of the present disclosure may be a system that designs a microprocessing unit (MCU) such that the MCU as a programmable sequencer operates as at least one of the root power manager and the domain power manager of FIG. 13.

The programmable sequencer design system according to the present disclosure may include a screen window processor 510 that detects user input and outputs a processing result for the user input on a display screen, an execution process design unit 520 that generates at least one power instance for configuring a programmable sequencer on the basis of power component information, sets a register defining a function of the power instance, and sets instructions and data for driving the at least one power instance on the basis of at least one instruction component, a data storage 530 in which code logic for generating register hardware code and binary code of instructions and data on the basis of power component information, instruction component information, and information on a designed execution process is stored, and a hardware code processor 540 that generates a power element on the basis of designed power instance information, determines a register field related to the power element, generates hardware code by combining the power element and the register field, and generates binary code of instructions and data for driving the power element.

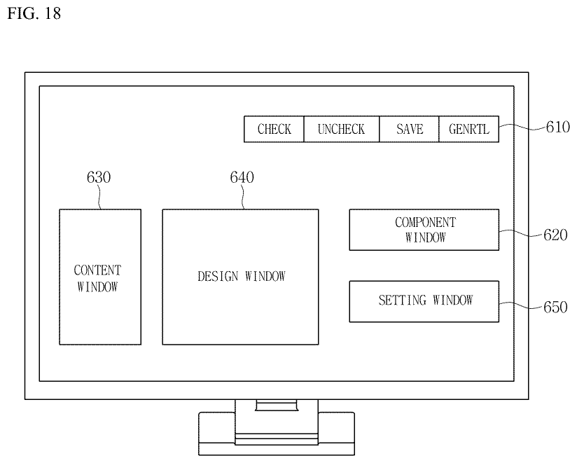

FIG. 18 is a diagram showing an example of a display screen of the no-code type programmable sequencer design system according to the present disclosure. The display screen of the design system according to the present disclosure may include a command window 610 to which a user command is input, a component window 620 in which power component icons or instruction component icons are displayed, a content window 630 which provides an environment for adding, deleting, and changing a list of power management units under design and hierarchically displays at least one programmable sequencer included in each power management unit under design, a list of power instances constituting an arbitrary programmable sequencer, and register information of each power instance, a design window 640 which provides an environment for adding, deleting, and changing at least one power instance constituting a programmable sequencer under design and provides an environment for adding, deleting, and changing an instruction instance for setting an execution process for a power instance of a programmable sequencer under design, and a setting window 650 which provides an environment for changing a setting value for a power instance selected through the design window 640 and an environment for selecting a power instance and inputting a value for a command instance.

The command window 610 may include a CHECK button for receiving a check command for errors in a power management unit under design, a programmable sequencer, and power instances, an UNCHECK button for receiving a command for disabling a check result, a SAVE button for receiving a save command for a power management unit under design, a programmable sequencer, and power instances displayed in the design window 640, and a GENRTL button for receiving a command for generating hardware code for power instances of a programmable sequencer displayed in the design window 640.

The component window 620 may display a list of power component icons and a list of command component icons that can be used in designing a power management unit. If a programmable sequencer to be designed is a domain power manager, power components may include a reset component for transmitting a reset signal to a power domain, an isolation component for transmitting an isolation signal to the power domain, a switch control component for transmitting a switch control signal to the power domain, a retention component for transmitting a retention signal to the power domain, an automatic power manager component for automatically performing power up/down by a trigger signal of hardware, a reference clock gating component for gating a reference clock supplied to the power domain, a memory component for generating a power control signal for a memory of the power domain, a handshake component for generating a handshake control signal with respect to the power domain, a clock link component for generating a link control signal with respect to a clock management unit, a P-channel handshake component for generating a P-channel handshake control signal with respect to the power domain, a user-defined output component for generating a user-defined output signal within the power domain, a user-defined input component for generating a user-defined input signal within the power domain, etc.

If a programmable sequencer to be designed is a root power manager, power components that can be utilized in the designing of the root power manager may include a component for generating a register used for information purposes in software, a component for generating a register used for timeout purposes in software, a component for generating a register used for information transmission between upper software and the root power manager, a component for storing specific signal values input to the root power manager in an internal register of the root power manager, a component for generating an interrupt by control of an internal register of the root power manager, a component for generating an interrupt by an external input that is input to an input port of the root power manager, a component for generating an internal timer, and a component for generating a slot for connecting a domain power manager to a lower level of the root power manager.

Command components may include a write component for writing a specific value to a specific register field, a readwait component for waiting for a specific value to be input to a specific register field, a wait component for waiting for a certain period of time, an if component for branching depending on a condition, a goto component for moving to a specific position, and a call component for moving to a specific position but being able to return. In addition, auxiliary command components may include a label component, a start component, and an end component. The command components and the auxiliary command components may have their own border shapes. For example, the write component and the readwait component may have rectangular borders, the if component may have a diamond-shaped border, and the label component may have an arrow-shaped border. The label component may be used in connection with a command component, and may allow two or more command components that are spaced apart from each other to be actually connected. At least two label components may be used in the design window, and a name and a color for identification may be set for each label component.

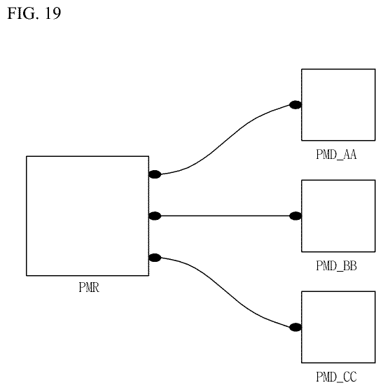

The design window 640 displays a diagram of a programmable sequencer that constitutes a power management unit under design and provides an environment for adding, deleting, and changing the programmable sequencer. FIG. 19 shows an example of a diagram of a power management unit displayed in the design window. The power management unit is composed of four programmable sequencers and may include one root power manager PMR and three domain power managers PMD_AA, PMD_BB, and PMD_CC, but is not limited thereto.

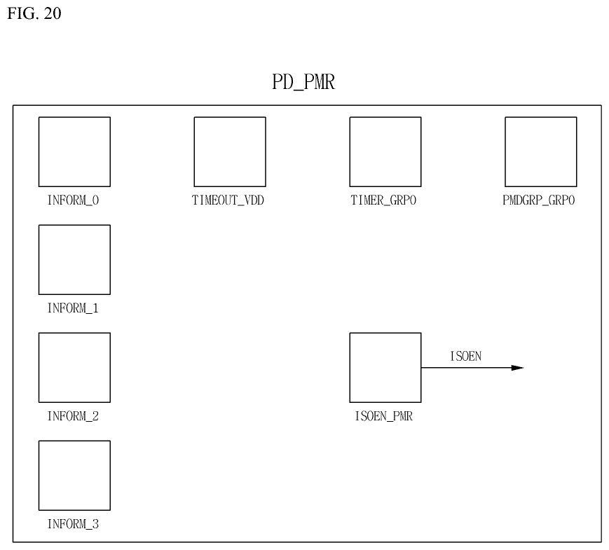

In addition, the design window 640 displays power instances of a programmable sequencer under design and provides an environment for adding, deleting, and changing the power instances that constitute the programmable sequencer under design. FIG. 20 shows an example of a diagram of a root power manager displayed in the design window. The root power manager is composed of, but is not limited to, eight power instances including four INFORM instances INFORM_0, INFORM_1, INFORM_2, and INFORM_3, one TIMEOUT instance TIMEOUT_VDD, one TIMER instance TIMER_GRPO, one slot generation (PMDDGPR) instance PMDGRP_GRPO, and one isolation (ISOEN) instance ISOEN_PMR.

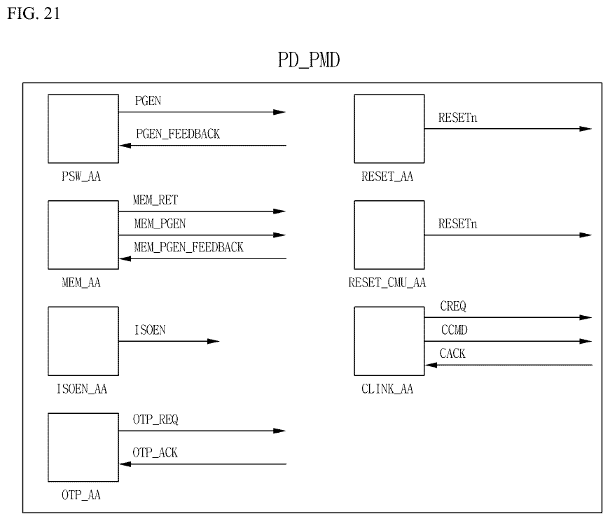

FIG. 21 shows an example of a diagram of a domain power manager displayed in the design window. The domain power manager is composed of, but is not limited to, seven power instances including one switch control instance PSW_AA, one reset instance RESET_AA, one isolation instance ISOEN_AA, one memory instance (MEM_AA), one handshake (OTP) instance OTP_AA, one clock link instance CLINK_AA, and one clock reset instance RESET_CMU_AA.

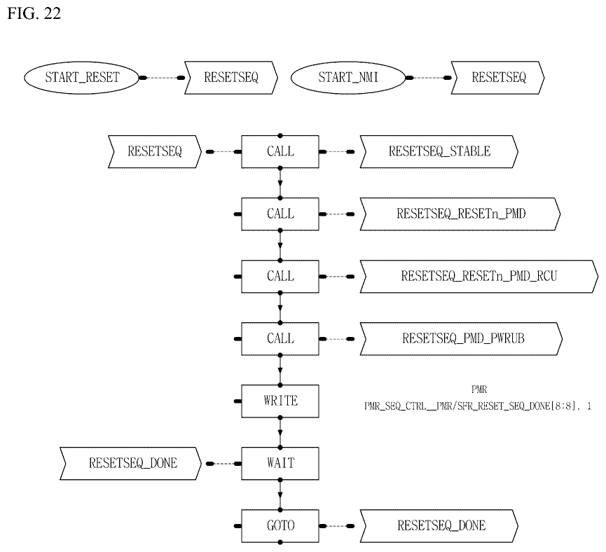

After power instances of a programmable sequencer is designed, the design window 640 may display an execution process diagram such that a connection relationship between instruction instances can be set. FIG. 22 shows an example of an execution process diagram of a programmable sequencer displayed in the design window. In the execution process shown in FIG. 22, two power instances RESET and NMI may be set to the same process. Two start instances START_RESET and START_NMI and a call instance may be practically connected through a label instance RESETSEQ. Another isolated instruction instance may be connected through a label instance connected to the back of the call instance. In the example diagram of FIG. 22, the call instance CALL, write instance WRITE, wait instance WAIT, and goto instance GOTO are used, but the present disclosure is not limited thereto.

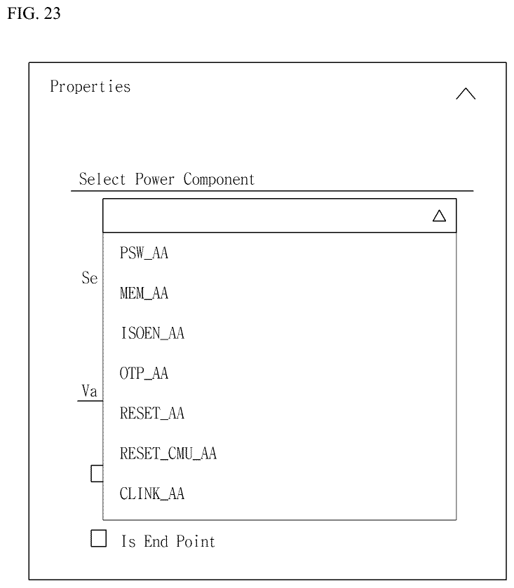

A power instance that is an instruction execution target and a value may be set for each instruction instance. FIG. 23 shows an example of a screen for setting a target power instance of an arbitrary instruction instance. When an instruction instance is added, all power instances included in a relevant programmable sequencer are displayed such that one power instance can be selected from among all power instances.

A connection relationship between instruction instances may be indicated by an arrow connecting the instruction instances, and this connection relationship between the instruction instances may determine the execution order of the instruction instances. The present disclosure can express and design an execution process of a programmable sequencer in the form of a flowchart.

When the user moves an arbitrary power component on the component window 620 to the design window 640 through a drag-and-drop operation, a power instance may be added to the programmable sequencer under design, and when the power instance is generated, a new power instance list and register information of the new power instance may be hierarchically added to the content window 630.

The settings window 650 displays am environment for changing setting values for a power instance selected through the design window 640, and displays an environment for selecting and changing a power instance and an environment for inputting values for an instruction instance selected through the design window 640.

The screen window processor 510 may include a command window processor 511 that displays buttons for receiving a user command on the command window 610, detects an input applied to each button on the command window 610, and causes an operation related to the input button to be performed, a content window processor 512 that hierarchically displays a list of power management units under design, a list of programmable sequencers included in each power management unit under design, a list of power instances included in each programmable sequencer, and register information on the content window 630, detects user input applied to the content window 630, and causes an operation related to the user input to be performed, a design window processor 513 that displays a power diagram of a power management unit under design selected by the user on the design window 640, detects user input applied to the design window 640, and causes an operation related to the user input to be performed, and a setting window processor 514 that causes the setting window 650 to display configuration information of a power instance selected by the user or display configuration information of an instruction instance selected by the user, detects user input applied to the setting window 650, and causes an operation related to the user input to be performed.

The command window processor 511 performs a check operation for errors in a diagram of a power management unit under design, programmable sequencers constituting the power management unit under design, the types and setting values of power instances included in each programmable sequencer, etc. when the CHECK button is selected such that a part where an error has occurred is displayed. When the UNCHECK button is selected, the command window processor 511 restores the error part displayed in the diagram of the power management unit under design to its original state and displays the same. When the SAVE button is selected, the command window processor 511 saves the power management unit under design and subcomponents thereof displayed in the design window 640 in the data storage 530. When the GENRTL button is selected, the command window processor 511 generates hardware code for a programmable sequencer under design displayed in the design window 640 and binary code for instructions and data for executing the programmable sequencer.

The content window processor 512 provides an environment for adding, deleting, and changing a list of power management units under design, a list of programmable sequencers included in each power management unit under design, and a list of power instances included in each programmable sequencer under design. The content window processor 512 displays a list of programmable sequencers included in each power management unit under design under each power management unit under design, and hierarchically displays a list of power instances included in each programmable sequencer and register information of each power instance under each programmable sequencer under design. Here, a power management unit may include at least one root power manager and at least one domain power manager under each root power manager. Both the root power manager and the domain power manager may be implemented as a programmable sequencer, and therefore, the power management unit may include a plurality of programmable sequencers.

The user may add, delete, or rename a power management unit under design on the content window 630, and a list of power management units under design may be added, deleted, or renamed in the content storage 532 in response to user input. When the user changes the name of a power management unit under design, the content window processor 512 may change not only the name of the power management unit under design, but also the name of a programmable sequencer under the power management unit under design, the name of a power instance under the programmable sequencer, and the register name of the power instance all at once.

The design window processor 513 displays a diagram of a power management unit under design in the design window 640, provides an environment for adding, deleting, and changing a programmable sequence that constitutes the power management unit under design, displays a diagram of each programmable sequencer, and provides an environment for adding, deleting, and changing a power instance that constitutes a programmable sequence. When the user performs an operation of adding an arbitrary power component on the component window 620 to the design window 640, the design window processor 513 detects this operation and causes a power instance adding operation to be performed. In addition, when the user performs an operation of adding an arbitrary instruction component on the component window 620 to the design window 640, the design window processor 513 detects this operation and causes an instruction instance adding operation to be performed.

The setting window processor 514 displays configuration information of a power instance selected by the user in the setting window 650, detects user input applied to the setting window 650, and causes an operation related to the user input to be performed. In addition, the setting window processor 514 displays configuration information of an instruction instance selected by the user, detects user input applied to the setting window 650, and causes an operation related to the user input to be performed.

The data storage 530 may include a component storage 531 in which power component information and instruction component information are stored, a content storage 532 in which a list of power management units under design, a list of programmable sequencers for each power management unit under design, a list of power instances for each programmable sequencer, and register information related to the power instances are stored, an execution process storage 533 in which instruction instances set for an execution process of a programmable sequencer and power instance information and values that are targets of each instruction instance are stored, and a code logic storage 534 in which hardware code logic for generating hardware code on the basis of designed power instances and register information is stored and software code logic for generating binary code of an execution process for executing a programmable sequencer on the basis of designed instruction instances is stored. The programmable sequencer execution process may include instructions, register addresses, and data.

Power component information stored in the component storage 531 may include an address range allocated to each power component and a register offset size for each individual power component. The power component information defines a register address and field value of a power instance generated on the basis of the relevant power component. Information on the maximum number of power instances per power component may be calculated using the address range allocated to each power component and the register offset size of each individual power component. The address range allocated to each power component, the register offset size of each individual power component, and configuration field information for each individual power component may all be determined differently.

Power components may include at least one of a reset component, an isolation component, a switch control component, a retention component, an automatic power manager component, a reference clock gating component, a memory component, a handshake component, a clock link component, a P-channel handshake component, a user-defined output component, and a user-defined input component.

In addition, the power components may include at least one of a component for generating a register used for information purposes in software, a component for generating a register used for timeout purposes in software, a component for generating a register used for information transmission between upper software and a root power manager, a component for storing specific signal values input to the root power manager in an internal register of the root power manager, a component for generating an interrupt by control of an internal register of the root power manager, a component for generating an interrupt by an external input that is input to an input port of the root power manager, a component for generating an internal timer, and a component for generating a slot for connecting a domain power manager to a lower level of the root power manager.

Instruction components stored in the component storage 531 may include a write component for writing a specific value to a specific register field, a readwait component for waiting for a specific value to be input to a specific register field, a wait component for waiting for a certain period of time, an if component for branching depending on a condition, a goto component for moving to a specific position, a call component for moving to a specific position but being able to return, etc. In addition, auxiliary instruction components may include a label component, a start component, and an end component. The instruction components and auxiliary instruction components may have their own border shapes. For example, the write component and the readwait component may have a rectangular border, the if component may have a diamond-shaped border, and the label component may have an arrow-shaped border. The label component may be used in connection with an instruction component, and may enable any two instruction components that are separated from each other to be substantially connected. A name and a color for identification may be set for the label component.

The content storage 532 hierarchically stores programmable sequencers included in a power management unit under design, power instances included in the programmable sequencers, and a register for each power instance.

The execution process storage 533 stores instruction instances set for driving a programmable sequencer and execution order information of the instruction instances, and stores power instance information and values that are targets of each instruction instance for each instruction instance. When the user drags and drops an instruction component onto the design window 640, an instruction instance on the basis of the instruction component is generated. At this time, a power instance and a value that are targets of the instruction instance may be set. That is, when the instruction component is a write component, a power instance (e.g., reset instance or isolation instance) and a value (data) to be written to the power instance need to be set. Here, the power instance is a target power instance, and the value is a value. In the present disclosure, since a register section is determined for each power instance, when a target power instance of an instruction instance is determined, a field address of the power instance may be determined.

As shown in FIG. 15, information stored in the execution process storage 533 in order to design a programmable sequencer for operating from a power-up state to a power-down state is, for example, in the order of “instruction instance-target power instance-value” as follows.
1. Write instance—reset instance—0
2. Write instance—isolation instance—1
3. Write instance—switch control instance—1

Information stored in the execution process storage 533 in order to design a programmable sequencer that operates from the next power down state to a power up state is in the order of “instruction instance—target power instance—value” as follows.
1. Write instance—switch control instance—0
2. Write instance—isolation instance—0
3. Write instance—reset instance—1

The instruction instance may be at least one of a write instance based on a write component, an input wait instance based on a readwait component, a wait instance based on a wait component, an if instance based on an if component, a goto instance based on a goto component, and a call instance based on a call component.

The target power instance may be at least one of power instances that constitute a programmable sequencer under design.

The value may be input as a decimal number or a hexadecimal number.

The code logic storage 534 stores hardware code logic for generating hardware code based on a designed power instance and register information, and stores software code logic for generating binary code of instructions, register addresses, and data for executing a programmable sequencer on the basis of a designed instruction instance.

The execution process design unit 520 may include a power instance management unit 521 that generates a new power instance on the basis of information on a previously generated power instance information of the same power component type and power component information and stores the same in the content storage 532, an instruction instance management unit 522 that stores at least one instruction instance and an execution order of any two instruction instances and stores a target power instance and value for each instruction instance in the execution process storage 533, and a register setting unit 523 that sets field values of registers that define functions of power instances.

The power instance management unit 521 may be executed when the user adds any power component on the component window 620 to the design window 640 to generate a new power instance. The name of the new power instance may include the name of a programmable sequencer including the new power instance and power component type information of the new power instance. In addition, the address of the new power instance may be set on the basis of information on a previously generated power instance of the same power component type and power component information. That is, the start address of the register of the new power component may be determined by adding the start address of the register of the previously generated power instance to the register offset size thereof, and an initial setting value of a register field may be determined on the basis of register field information of the power component information.

The instruction instance management unit 523 may set at least one instruction instance and a connection relationship between instruction instances according to a programmable sequencer execution process. Each instruction instance may include a target power instance and a value. The instruction instance management unit 523 may add a label instance between any two instruction instances. A pair of label instances may be recognized as the same point, and therefore, two instruction instances that are separated from each other may be substantially connected using a pair of label instances. In addition, a start instance and an end instance may be added to the start and end points of an execution process to set the start and end.

The register setting unit 523 may display the field name, bit position, and the like of a register field of a power instance in the design window 640 or the setting window 650, and may change the same according to user input.

The hardware code processor 540 includes a power element generator 541 that generates a power element on the basis of information on a designed power instance, a register code generator 542 that generates register code related to the power element, a hardware code generator 543 that generates hardware code by combining the power element and a register, and an execution process code generator 544 that generates binary code of an execution process of a programmable sequencer.

The hardware code processor 540 may be executed when the GENRTL button on the command window 610 is selected. The user may select and execute the GENRTL button while a diagram of a power management unit under design is displayed in the design window 640, and may also execute the CHECK button before executing the GENRTL button to verify in advance whether there is an error in the diagram.

The power element generator 541 may convert information on a designed power instance in accordance with hardware code logic stored in the code logic storage 534 to generate a power element that constitutes a programmable sequencer. The port type of the power element and a hierarchical structure of hardware modules may be determined according to configuration of the designed power instance.

The register code generator 542 may generate register code of a register bank according to the hardware code logic on the basis of register field values of the designed power instance, and ports of the register bank corresponding to ports of the power element may be generated.

The hardware code generator 543 automatically connects the ports of the power element and the ports of the register bank according to the hardware code logic, and generates hardware code (RTL code) reflecting setting values of the power instance.

The execution process code generator 544 generates binary code of an execution process on the basis of the software code logic stored in the code logic storage 534. The execution process may include an instruction, a register address, and data. The instruction may be derived on the basis of an instruction instance, the register address may be derived on the basis of a target power instance, and the data may be derived on the basis of a value. The binary code derived in this way is stored in the memory 1315, and the processing unit 211 may read the binary code and execute the instruction targeting the address of the register bank to transmit a power control signal to a power domain.

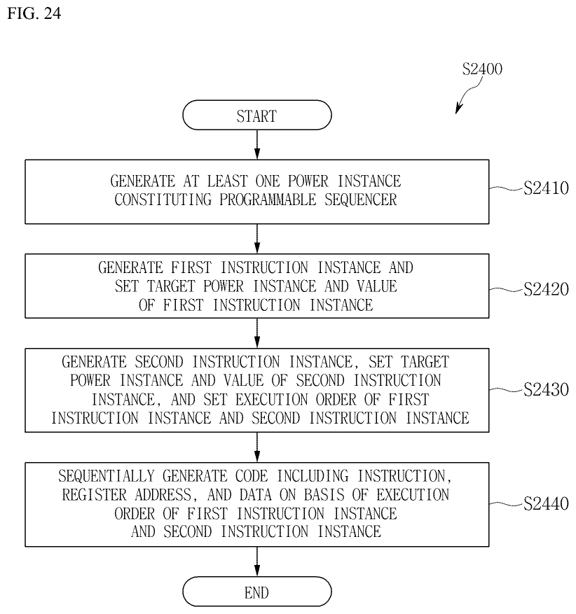

FIG. 24 is an operation flowchart illustrating a no-code type programmable sequencer design method according to the present disclosure. The programmable sequence design method according to the present disclosure may be executed by a processor of a computer system. The computer system includes a component storage in which power component information and instruction component information are stored and a code logic storage in which software code logic for generating code on the basis of an instruction instance is stored.

The processor generates at least one power instance constituting a programmable sequencer (S2410). Step S2410 may be repeatedly performed until all power instances constituting the programmable sequencer are generated.

The processor generates a first instruction instance on the basis of an instruction component, and sets a target power instance and value of the first instruction instance among at least one power instance constituting the programmable sequencer (S2420). The target power instance and value of the first instruction instance may be set by user input.

The processor generates a second instruction instance on the basis of an instruction component, sets a target power instance and value of the second instruction instance among at least one power instance constituting the programmable sequencer, and sets an execution order of the first instruction instance and the second instruction instance (S2430). The target power instance and value of the second instruction instance may be set by user input. In addition, the execution order of the first instruction instance and the second instruction instance may be set by user input. The target power instance of the first instruction instance and the target power instance of the second instruction instance may be the same or different.

The processor sequentially generates code including an instruction, a register address, and data on the basis of the first instruction instance and code including an instruction, a register address, and data on the basis of the second instruction instance on the basis of the execution order of the first instruction instance and the second instruction instance (S2440).

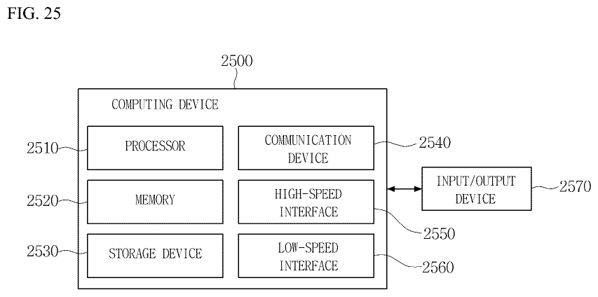

FIG. 25 illustrates an exemplary computing device 2500 for performing the methods and/or embodiments described above. According to one embodiment, the computing device 2500 may be implemented using hardware and/or software configured to interact with a user. Here, the computing device 2500 may include, but is not limited to, a laptop, a desktop, a workstation, a personal digital assistant, a server, a blade server, a main frame, and the like. The components of the computing device 1300, connection relationships thereof, and functions thereof are intended to be exemplary and are not intended to limit implementations of the present disclosure described and/or claimed herein.

The computing device 2500 includes a processor 2510, a memory 2520, a storage device 2530, a communication device 2540, a high-speed interface 2550 connected to the memory 2520 and a high-speed expansion port, and a low-speed interface 2560 connected to a low-speed bus and the storage device. The components 2510, 2520, 2530, 2540, 2550, and 2560 may be interconnected using various buses and may be mounted on the same main board or may be mounted and connected in another suitable manner. The processor 2510 may be configured to process instructions of a computer program by performing basic arithmetic, logic, and input/output operations. For example, the processor 2510 may process instructions stored in the memory 2520 and the storage device 2530, and/or instructions executed in the computing device 2500 to display graphical information on an external input/output device 2570, such as a display device coupled to the high-speed interface 2550.

The communication device 2540 may provide a configuration or function for the input/output device 2570 and the computing device 2500 to communicate with each other through a network, and may provide a configuration or function for supporting communication between the input/output device 2570 and/or the computing device 2500 and other external devices. For example, a request or data generated by a processor of an external device according to any program code may be transmitted to the computing device 2500 through a network under the control of the communication device 2540. Conversely, a control signal or command provided under the control of the processor 2510 of the computing device 2500 may be transmitted to another external device through the communication device 2540 and the network.

Although the computing device 2500 is illustrated as including one processor 2510, one memory 2520, etc. in FIG. 25, the present disclosure is not limited thereto, and the computing device 2500 may be implemented using a plurality of memories, a plurality of processors, and/or a plurality of buses. Additionally, although FIG. 25 illustrates one computing device 2500, the present disclosure is not limited thereto, and a plurality of computing devices may interact and perform operations necessary to execute the method described above.

The memory 2520 may store information within the computing device 2500. In one embodiment, the memory 2520 may be configured as a volatile memory unit or a plurality of memory units. Additionally or alternatively, the memory 2520 may be configured as a non-volatile memory unit or a plurality of memory units. In addition, the memory 2520 may be configured as computer-readable media in a different form, such as a magnetic disc or an optical disc. In addition, the memory 2520 may store an operating system and at least one program code and/or instruction.

The storage device 2530 may be one or more mass storage devices for storing data for the computing device 2500. For example, the storage device 2530 may be a computer-readable medium including a magnetic disc such as a hard disk or a removable disk, an optical disc, a semiconductor memory device such as an erasable programmable read-only memory (EPROM), an electrically erasable PROM (EEPROM), or a flash memory device, a CD-ROM, and a DVD-ROM disk, or may be configured to include such a computer-readable medium. In addition, a computer program may be tangibly implemented in such a computer-readable medium.

The high-speed interface 2550 and the low-speed interface 2560 may be means for interacting with the input/output device 2570. For example, the input device may include devices such as a camera including an audio sensor and/or an image sensor, a keyboard, a microphone, and a mouse, and the output device may include devices such as a display, a speaker, and a haptic feedback device. In another example, the high-speed interface 2550 and the low-speed interface 2560 may be means for interfacing with a device that integrates a configuration or function for performing input and output, such as a touchscreen.

In one embodiment, the high-speed interface 2550 may manage bandwidth-intensive operations for the computing device 2500, whereas the low-speed interface 2560 may manage less bandwidth-intensive operations than the high-speed interface 2550, but such functional allocation is merely exemplary. In one embodiment, the high-speed interface 2550 may be coupled to the memory 2520, the input/output devices 2570, and high-speed expansion ports that may accommodate various expansion cards (not shown). Additionally, the low-speed interface 2560 may be coupled to the storage device 2530 and a low-speed expansion port. Additionally, the low-speed expansion port, which may include various communication ports (e.g., USB, Bluetooth, Ethernet, and wireless Ethernet), may be coupled to one or more input/output devices 2570, such as a keyboard, a pointing device, a scanner, or a networking device, such as a router or a switch, via a network adapter.

The computing device 2500 may be implemented in a number of different forms. For example, the computing device 2500 may be implemented as a standard server, or as a group of such standard servers. Additionally or alternatively, the computing device 2500 may be implemented as a part of a rack server system, or as a personal computer, such as a laptop computer. In such cases, components of the computing device 2500 may be combined with other components within any mobile device (not shown). The computing device 2500 may include one or more other computing devices, or may be configured to communicate with one or more other computing devices.

Although the input/output device 2570 is illustrated as not being included in the computing device 2500 in FIG. 25, the present disclosure is not limited thereto, and the input/output device 2570 may be configured to be integrated with the computing device 2500. In addition, although the high-speed interface 2550 and/or the low-speed interface 2560 are illustrated as elements configured separately from the processor 2510 in FIG. 25, the present disclosure is not limited thereto, and the high-speed interface 2550 and/or the low-speed interface 2560 may be configured to be included in the processor 2510.

The above-described method and/or various embodiments may be realized by digital electronic circuits, computer hardware, firmware, software, and/or a combination thereof. Various embodiments of the present disclosure may be implemented by a data processing device, for example, one or more programmable processors and/or one or more computing devices, or as a computer-readable medium and/or a computer program stored on a computer-readable medium. The computer program described above may be written in any programming language, including compiled or interpreted languages, and may be distributed in any form, such as a standalone program, a module, or a subroutine. The computer program may be distributed through a single computing device, a plurality of computing devices connected through the same network, and/or a plurality of computing devices distributed to be connected through a plurality of different networks.

The above-described method and/or various embodiments may be performed by one or more processors configured to execute one or more computer programs that process, store and/or manage any function and the like by operating on the basis of input data or generating output data. For example, the method and/or various embodiments of the present disclosure may be performed by a special purpose logic circuit such as a field programmable gate array (FPGA) or an application specific integrated circuit (ASIC), and a device and/or a system for performing the method and/or embodiments of the present disclosure may be implemented as special purpose logic circuits such as an FPGA or an ASIC.

The one or more processors executing a computer program may include one or more processors of a general purpose or special purpose microprocessor and/or any kind of digital computing device. The processor may receive instructions and/or data from each of a read-only memory and a random access memory, or may receive instructions and/or data from the read-only memory and the random access memory. In the present disclosure, components of a computing device performing the method and/or embodiments may include one or more processors for executing instructions, and one or more memories for storing instructions and/or data.

In one embodiment, the computing device may transmit/receive data to/from one or more mass storage devices for storing data. For example, the computing device may receive data from a magnetic disc or an optical disc and/or transmit data to the magnetic disc or the optical disc. A computer-readable medium suitable for storing instructions and/or data associated with a computer program may include, but is not limited to, any form of non-volatile memory, including semiconductor memory devices such as an erasable programmable read-only memory (EPROM), an electrically erasable PROM (EEPROM), and a flash memory device. For example, the computer-readable medium may include a magnetic disc, such as an internal hard disk or a removable disk, a photomagnetic disc, a CD-ROM, and a DVD-ROM disk.

To provide interaction with a user, the computing device may include, but is not limited to, a display device (e.g., a cathode ray tube (CRT), a liquid crystal display (LCD), or the like) for providing or displaying information to the user, and a pointing device (e.g., a keyboard, a mouse, a trackball, or the like) for enabling the user to provide input and/or commands to the computing device. That is, the computing device may further include any other types of devices for providing interaction with the user. For example, the computing device may provide any form of sensory feedback to the user, including visual feedback, auditory feedback, and/or tactile feedback, for interacting with the user. In this regard, the user may provide input to the computing device through various gestures, such as vision, voice, and motion.

In the present disclosure, various embodiments may be implemented in a computing device including a back-end component (e.g., a data server), a middleware component (e.g., an application server), and/or a front-end component. In this case, the components may be interconnected by any form or medium of digital data communication, such as a communication network. In one embodiment, the communication network may include a wired network such as Ethernet, a power line communication), a telephone line communication device, and RS-serial communication, a wireless network such as a mobile communication network, a wireless LAN (WLAN), Wi-Fi, Bluetooth, and ZigBee, or a combination thereof. For example, the communication network may include a local area network (LAN), a wide area network (WAN), or the like.

The computing device based on the exemplary embodiments described herein may be implemented using hardware and/or software configured to interact with a user, including a user device, a user interface (UI) device, a user terminal, or a client device. For example, the computing device may include a portable computing device such as a laptop computer. Additionally or alternatively, the computing device may include, but is not limited to, a personal digital assistant (PDA), a tablet PC, a game console, a wearable device, an Internet-of-Things (IoT) device, a virtual reality (VR) device, an augmented reality (AR) device, and the like. The computing device may further include other types of devices configured to interact with a user. Furthermore, the computing device may include a portable communication device (e.g., a mobile phone, a smartphone, a wireless cellular phone, and the like) suitable for wireless communication over a network, such as a mobile communication network. The computing device may be configured to wirelessly communicate with a network server using wireless communication technologies such as Radio Frequency (RF), Microwave Frequency (MWF), and/or Infrared Ray Frequency (IRF) and/or protocols.

Various embodiments including specific structural and functional details in the present disclosure are exemplary. Therefore, the embodiments of the present disclosure are not limited to those described above, and may be implemented in various other forms. In addition, the terms used in the present disclosure are intended to describe some embodiments and are not to be construed as limiting the embodiments. For example, singular words and the above may be construed to include plural forms unless the context clearly indicates otherwise.

In the present disclosure, unless otherwise defined, all terms used in this specification, including technical or scientific terms, have the same meaning as commonly understood by a person skilled in the art to which such concepts belong. In addition, commonly used terms, such as terms defined in the dictionary, should be interpreted as having a meaning consistent with the meaning in the context of the relevant technology.

Although the present disclosure has been described in connection with some embodiments herein, various modifications and changes may be made without departing from the scope of the present disclosure as understood by a person skilled in the art to which the present disclosure belongs. In addition, such modifications and changes should be considered to fall within the scope of the claims appended hereto.

What is claimed is:

1. An apparatus for automation of semiconductor system design, comprising:
a semiconductor component storage unit in which component information on various semiconductor components utilizable in semiconductor system design is stored;
a semiconductor design operation input unit configured to receive a selection and arrangement operation of a user for at least one semiconductor component; and
a semiconductor system automatic design unit configured to automate a design of a semiconductor system including the at least one semiconductor component according to the selection and arrangement operation of the user.

2. The apparatus of claim 1, wherein the semiconductor design operation input unit comprises a graphical user interface configured to perform a selection and arrangement operation on the at least one semiconductor component according to a drag-and-drop operation of the user for the at least one semiconductor component.

3. The apparatus of claim 1, wherein the semiconductor components include at least one of one or more clock components constituting a clock management unit design of a semiconductor system, one or more power components constituting a power management unit design of a semiconductor system, and one or more semiconductor circuit components constituting a semiconductor circuit design of a semiconductor system.

4. The apparatus of claim 3, wherein the semiconductor design operation input unit provides a graphical user interface for inputting, by drawing, a clock diagram representing a clock management unit, a power diagram representing a power management unit, and an IP diagram representing a connection relationship between a semiconductor circuit block and the clock management unit and the power management unit to a computing device.

5. The apparatus of claim 4, wherein the semiconductor system automatic design unit includes at least one of a clock management unit automatic design unit configured to automate a design of the clock management unit, a power management unit automatic design unit configured to automate a design of the power management unit, and a semiconductor circuit automatic design unit configured to automate a design of the semiconductor circuit.

6. The apparatus of claim 5, wherein the semiconductor system automatic design unit defines at least part of the component information on the basis of drawing information of the clock diagram, the power diagram, and the IP diagram drawn through the graphical user interface.

7. The apparatus of claim 6, wherein the semiconductor system automatic design unit comprises:
an instance processor configured to design an instance related to the semiconductor component on the basis of a field value of a register defining a function of an individual component; and
a hardware code processor configured to generate an element based on a plurality of instances and generate hardware code related to the design of the element.

8. The apparatus of claim 7, wherein the hardware code processor generates a register module related to the element and generates the hardware code by combining the element and the register module, and
the apparatus further comprises a hardware code logic storage configured to store hardware code logic for generating a designed instance as hardware code.

9. The apparatus of claim 8, wherein the instance processor designs a new instance by setting a field value of a register defining a function of the new instance on the basis of component information of a preceding instance generated prior to the new instance and component information of the new instance.

10. The apparatus of claim 9, wherein the hardware code processor generates a register module related to an element including the preceding instance and the new instance on the basis of the field value of the register of the designed new instance and the hardware code logic, and generates the hardware code by combining the element and the register module.

11. The apparatus of claim 10, wherein the hardware code generated by the hardware code processor comprises:
hardware code for a function module enabled on the basis of a setting value of a register field of the new instance, information on an enabled function module of the new instance, and the hardware code logic;
hardware code of the register module for operating the enabled function module; and
hardware code of a port and hardware code of a connection for connecting the register module and the enabled function module.

12. The apparatus of claim 10, wherein the semiconductor system automatic design unit automatically generates the hardware code by the hardware code processor according to the selection and arrangement operation of the user for the semiconductor components to automate a design of the semiconductor system based on no-code.

13. The apparatus of claim 7, wherein the semiconductor component storage unit comprises a component storage in which component information for defining a register address and a field value of the instance is stored,
wherein the component information includes an address range allocated to an individual component, an alignment size of an individual component, a base register offset size of an individual component, and configuration field information of an individual component,
wherein the configuration field information of an individual component includes a field name, a bit position, a bit size, access permission, and an initial value.

14. The apparatus of claim 1, further comprising a code logic storage in which software code logic for generating code based on an instruction instance is stored.

15. The apparatus of claim 1, wherein the semiconductor component storage unit comprises a component storage in which the component information and instruction component information are stored, and
the semiconductor system automatic design unit generates one or more instances constituting a programmable sequencer on the basis of the component information, generates a first instruction instance on the basis of the instruction component information, determines a target instance related to the first instruction instance among the one or more instances and sets a value related to the target instance, and generates code including an instruction, a register address, and data on the basis of the first instruction instance, the target instance, and the value.

16. The apparatus of claim 15, wherein the instruction component information includes at least one of a write component for writing a specific value to a specific register field, a read-wait component for waiting for a specific value to be input to a specific register field, a wait component for waiting for a predetermined period of time, an if component for branching depending on a condition, a go-to component for moving to a specific position, and a call component for moving to a specific position but being able to return.

17. The apparatus of claim 1, wherein the component information includes at least one of an attribute of the semiconductor component, a control signal related to the semiconductor component, a clock frequency setting, a power state setting, a power control sequence, and a voltage setting of the semiconductor component.

18. A method of automating semiconductor system design, comprising:
receiving, by a semiconductor design operation input unit, a selection and arrangement operation of a user for at least one semiconductor component among various semiconductor components utilizable in semiconductor system design; and
automating, by a semiconductor system automatic design unit, a design of a semiconductor system including the at least one semiconductor component on the basis of the selection and arrangement operation of the user.

19. The method of claim 18, wherein the receiving comprises performing, by a graphical user interface unit, a selection and arrangement operation on the at least one semiconductor component according to a drag-and-drop operation of the user for the at least one semiconductor component, and
the automating of the design of a semiconductor system comprises:
designing an instance related to the at least one semiconductor component on the basis of a field value of a register defining a function of an individual component; and
generating an element based on a plurality of instances and generating hardware code related to the design of the element.

20. A computer-readable non-transitory recording medium on which a computer program for executing the method of automating semiconductor system design according to claim 18 is recorded.
